(19) United States
(12) Patent Application Publication
(10) Pub. No.: US 2006/0248346 A1
(43) Pub. Date: Nov. 2, 2006

(54) Method for generating device unique key, secret information LSI with secret information processing function using the method, host device mounted with the LSI, recording medium with authentication function used in the host device, and portable terminal with the recording medium having authentication function

(76) Inventors: Kentaro Shiomi, Nagaokakyo-shi (JP); Makoto Fujiwara, Kyoto-shi (JP)

Correspondence Address: MCDERMOTT WILL & EMERY LLP, 600 13TH STREET, N.W., WASHINGTON, DC, 20005-3096, US

(21) Appl. No.: 11/377,278

(22) Filed: Mar. 17, 2006

(30) Foreign Application Priority Data
Mar. 18, 2005 (JP) P2005-079465
Jul. 4, 2005 (JP) P2005195213

(51) Int. Cl. H04K 1/00

(52) U.S. Cl. 713/184

(57) ABSTRACT

To provide a device unique key for establishing a system for protecting a device unique ID including a user ID such as a phone number acquired from an external device when a host device such as a portable terminal is shipped or replaced, a change field information processing step 203 is a process for handing over designated change field information to a device unique ID generating step 205. In a user ID externally acquiring step 204, a user ID is acquired from an external device and stored in a host device. In the device unique ID generating step 205, the pieces of information (fixed ID, change field information and user ID) obtained in the encrypted fixed ID decryption processing step 202, the change field information processing step 203 and the user ID externally acquiring step 204 are integrated to generate a device unique ID. In a device unique key generating step 206, a device unique key is generated using the device unique ID generated in the device unique ID generating step 205.

### BACKGROUND OF THE INVENTION

1. Field of the Invention

The present invention relates to a method for generating a device unique key, a secret information LSI with a secret information processing function using the method, a host device mounted with the LSI, a recording medium with an authentication function used in the host device, and a portable terminal with the recording medium having an authentication function. Particularly, it relates to a method for changing a device unique ID including user information (user ID) such as a phone number in a system in which a device unique key is generated in accordance with the device unique ID including the user information when a host device such as a portable terminal is registered or replaced.

2. Description of the Related Art

There is a case where contents of music data, image data or games are downloaded to a host device such as a portable terminal from the Internet or a site managed by a portable phone company or the like, and the contents are stored in a target device so as to be used on the host device such as the portable terminal.

For example, the target device designates a memory card such as an SD card. There is often a charge for the contents, and the contents often include copyrighted ones. The contents cannot be copied but made usable only on the user's host device such as the portable terminal where the contents have been downloaded. Thus, the copyrights of the contents are protected.

The host device such as the portable terminal acquires a device unique ID including a user ID such as a phone number from an external device when the host device is registered or replaced. A device unique key is generated from the device unique ID. The contents are encrypted with the device unique key so that the contents can be used only on the user's host device such as the portable terminal where the contents have been downloaded. Thus, the copyrights of the contents are protected. JP-A-2002-342168 discloses a method for transferring data between host devices such as portable terminals while securing copyright protection of data stored in the host devices such as the portable terminals.

In the aforementioned background-art method for changing a device unique ID, a host device such as a portable terminal acquires a device unique ID including a user ID such as a phone number from an external device when the host device is shipped or replaced. However, the method has a problem that it is difficult to protect the device unique ID or deal with an illegal access.

### SUMMARY OF THE INVENTION

The present invention was developed in consideration of the foregoing situation. It is an object of the invention to provide a method for generating a device unique key to thereby establish a system for protecting a device unique ID including a user ID such as a phone number acquired from an external device when a host device such as a portable terminal is shipped or replaced, a secret information LSI with a secret information processing function using the method, a host device mounted with the LSI, a recording medium with an authentication function used in the host device, and a portable terminal with the recording medium having an authentication function.

A method for generating a device unique key according to the invention includes the steps of: integrating a fixed ID and a user ID to thereby generate a device unique ID, the fixed ID being determined for a host device in advance and stored in a storage portion of the host device, the user ID being able to be determined desirably by a user; and generating a device unique key based on the device unique ID.

In the method according to the invention, a fixed ID determined for a host device in advance and a user ID which can be determined desirably by a user are integrated to generate a device unique ID. Due to the device unique ID generated newly, protection of the device unique ID can be enhanced, and illegal access can be prevented.

The method for generating a device unique key according to the invention further includes the steps of: making a key generator of a key management mechanism encrypt the fixed ID to thereby generate an encrypted fixed ID; making a secret information processing portion of the host device decrypt the encrypted fixed ID and store the decrypted fixed ID as the fixed ID into the storage portion of the host device; making an I/F of the host device acquire the user ID the user can determine desirably; and making the secret information processing portion of the host device integrate the fixed ID and the user ID to thereby generate a device unique ID.

In the method according to the invention, a device unique key is generated based on an encrypted device unique ID obtained by encrypting a device unique ID. Accordingly, protection of the device unique ID can be enhanced, and illegal access can be prevented.

The method for generating a device unique key according to the invention includes a method in which the step of generating the device unique ID includes the steps of: generating change field information defining a field of the device unique ID in which the user ID should be input; and making the host device input the user ID into a desired field of the device unique ID in accordance with the change field information so as to integrate the user ID with the fixed ID to thereby generate the device unique ID. In addition, the method for generating a device unique key according to the invention includes a method including the step of setting the user ID in the desired field based on the change field information and then making the secret information processing portion of the host device integrate the user ID with the fixed ID so as to generate the device unique ID.

In the method according to the invention, a device unique ID is generated based on change field information defining a field of the device unique ID in which the user ID should be input. Accordingly, protection of the device unique ID can be enhanced, and illegal access can be prevented.

The method for generating a device unique key according to the invention includes a method further including the steps of: making the secret information processing portion of the host device encrypt the device unique ID to thereby generate an encrypted device unique ID; storing the encrypted device unique ID into the storage portion of the host device; and making the secret information processing portion of the host device generate a device unique key based on the device unique ID.

In the method according to the invention, an encrypted device unique ID is generated and stored in the storage portion as it is. When the encrypted device unique ID is used, the encrypted device unique ID is decrypted, and a device unique key is generated based on the decrypted device unique ID. Accordingly, protection of the device unique ID can be enhanced, and illegal access can be prevented. That is, when mutual authentication is established between the target device and the host device, an authentication key can be obtained. The device unique ID is bound with the authentication key so that a device unique key is generated. Here, the binding may be performed so that the authentication key is encrypted with the device unique ID, or a logical product is obtained between the device unique ID and the authentication key. In short, it is essential to associate the device unique ID with the authentication key to thereby obtain a device unique key.

The method for generating a device unique key according to the invention includes a method further including the steps of: making the secret information processing portion of the host device generate an authentication key based on mutual authentication between the host device and a target device; and making the secret information processing portion of the host device generate a device unique key based on the device unique ID and using the authentication key generated in the step of generating the authentication key.

In the method for generating a device unique key according to the invention, an authentication key is generated based on mutual authentication between the host device and the target device. When the mutual authentication is not established, a subsequent device unique ID generating process cannot be executed. Accordingly, illegal access from an unauthorized host device can be prevented.

The method for generating a device unique key according to the invention includes a method further including the steps of: making the key generator of the key management mechanism encrypt the change field information to thereby generate encrypted change field information, and store the encrypted change field information into the host device; and making the secret information processing portion of the host device acquire the encrypted change field information and decrypt the change field information.

In the method according to the invention, change field information is encrypted with a key so as to generate an encrypted change field information, while the encrypted change field information is decrypted with the key so as to acquire the change field information. Accordingly, protection of the device unique ID can be enhanced, and illegal access can be prevented.

The method for generating a device unique key according to the invention includes a method further including the step of making an external device I/F of the host device acquire the change field information from the external device.

In the method according to the invention, the host device acquires change field information from the external device. Accordingly, protection of the device unique ID can be enhanced, and illegal access can be prevented.

The method for generating a device unique key according to the invention includes a method in which the step of acquiring the change field information is a step of acquiring the change field information as encrypted change field information.

In the method according to the invention, the host device acquires change field information from the external device in the form of encrypted change field information. Accordingly, protection can be further enhanced, and illegal access can be prevented.

The method for generating a device unique key according to the invention includes a method further including the step of calculating a hash value of the change field information.

In the method according to the invention, a hash value of the change field information is calculated in the host device, and a hash value of the change field information is calculated in the key management mechanism or the like in advance and input to the host device, the hash values are compared in a comparison circuit. When the hash values do not coincide with each other, an abnormal termination process such as reset or suspension of a processing circuit is performed. Accordingly, protection of the device unique ID can be enhanced, and illegal access can be prevented.

The method for generating a device unique key according to the invention includes a method in which the change field information is plain text.

In the method according to the invention, the change field information is stored as plain text. Accordingly, confidentialty is poor but management is easy. When the change field information is plain text, it is desired from the point of view of confidentially that the change field information is stored, for example, in the secret information processing portion of the host device.

The method for generating a device unique key according to the invention includes a method further including the step of making an external device I/F of the host device acquire the user ID from an external device when the device unique ID is registered, exchanged, updated or changed.

In the method according to the invention, the user ID is acquired from the external device when the device unique ID is registered, exchanged, updated or changed. Accordingly, protection of the device unique ID can be enhanced, and illegal access can be prevented.

The method for generating a device unique key according to the invention includes a method in which the step of acquiring the user ID is a step of acquiring the user ID as an encrypted user ID.

In the method according to the invention, the host device acquires the user ID as an encrypted user ID from the external device. Accordingly, protection can be further enhanced, and illegal access can be prevented.

The method for generating a device unique key according to the invention includes a method further including the step of calculating a hash value of the user ID.

In the method according to the invention, a hash value of the user ID is calculated in the host device, and compared with a stored hash value calculated in the host device or the like by a comparison circuit. When the hash values do not coincide with each other, an abnormal termination process such as reset or suspension of a processing circuit is performed. Accordingly, protection of the device unique ID can be enhanced, and illegal access can be prevented.

The method for generating a device unique key according to the invention includes a method in which the user ID is plain text.

In the method according to the invention, the user ID is stored as plain text. Accordingly, confidentially is poor but management is easy. When the user ID is plain text, it is desired from the point of view of confidentialty that the user ID is stored, for example, in the secret information processing portion of the host device.

The method for generating a device unique key according to the invention includes a method further including the step of making a secret information processing portion of the host device judge the number of times with which the device unique ID has been changed, and update the device unique ID as long as the number of times with which the device unique ID has been changed is not larger than a predetermined number.

In the method according to the invention, the number of times with which the device unique ID has been changed is determined. When the number of times with which the device unique ID has been changed does not exceed a predetermined number, the device unique ID is updated. Accordingly, protection of the device unique ID can be enhanced, and illegal access can be prevented.

The method for generating a device unique key according to the invention includes a method further including the step of making the host device generate an authentication key from information stored in the host device and information stored in the target device.

According to the method according to the invention, illegal access can be prevented more surely.

The method for generating a device unique key according to the invention includes a method in which the host device stores initial-value of the user ID, and it is determined whether the initial-value of the user ID coincides with a user ID portion obtained by a secret information processing portion of the host device decrypting an encrypted fixed ID stored by the host device, or not.

In the method according to the invention, initial-value of the user ID is stored and compared with a user ID in each case. Accordingly, illegal access can be prevented more surely.

The method for generating a device unique key according to the invention includes a method further including the step of making a secret information processing portion of the host device encrypt the device unique ID to thereby generate an encrypted device unique ID, and outputting the encrypted device unique ID.

In the method according to the invention, the encrypted device unique ID is encrypted. Accordingly, even when the encrypted device unique ID is stored outside the secret information processing portion, confidentialty can be secured. Accordingly, falsification of the device unique ID or illegal access can be prevented.

The method for generating a device unique key according to the invention includes a method in which the host device stores initial-value of the user ID; and it is determined whether a user ID obtained by decrypting and then separating the encrypted device unique ID input again into the secret information processing portion coincides with the initial value of the user ID stored by the host device in advance, or not.

According to the method according to the invention, authentication can be performed more easily and more surely.

The method for generating a device unique key according to the invention includes a method further including the steps of: making a secret information processing portion of the host device encrypt the device unique ID to thereby generate an encrypted device unique ID; making the secret information processing portion of the host device decrypt an encrypted device unique ID to thereby generate a device unique ID, the encrypted device unique ID being input from the storage portion of the host device through an I/F of the host device; and comparing a user ID input from the outside of the host device through the I/F with a user ID portion of the decrypted device unique ID, and regarding the input user ID as unauthorized and suspending a subsequent encryption/decryption process when the input user ID does not coincide with the user ID portion of the decrypted device unique ID.

According to the method according to the invention, illegality can be found in an early stage.

The method for generating a device unique key according to the invention includes a method further including the steps of: making a key generator of a key management mechanism add a determination flag region and encrypt the fixed ID to thereby generate an encrypted fixed ID; making a secret information processing portion of the host device integrate the fixed ID with the user ID and update the determination flag region to thereby generate a device unique ID; and generating a device unique key based on the device unique ID.

According to the method according to the invention, when a determination flag region is added simply, whether the user ID has been updated or not can be determined without requiring a determination step in an early stage.

The method for generating a device unique key according to the invention includes a method further including the steps of: determining whether the determination flag region has been updated or not; and regarding the determination flag region as unauthorized and suspending processing when the determination flag region has not been updated.

According to the method according to the invention, illegality can be found in an early stage.

The method for generating a device unique key according to the invention includes a method in which the storage portion is disposed in a secret information processing portion.

According to the method, confidentialty can be secured more surely.

The method for generating a device unique key according to the invention includes a method in which the storage portion is disposed in the host device but out of a secret information processing portion of the host device.

According to the method, confidentialty becomes poor. However, if a non-volatile memory or the like is used as the storage portion, the contract details can be taken over extremely easily when the terminal device is changed and updated.

The method for generating a device unique key according to the invention includes a method in which the user ID is encrypted, and input as an encrypted user ID to the secret information processing portion of the host device.

In the method according to the invention, the user ID can be hidden. Accordingly, security can be further enhanced.

A device unique ID according to the invention includes: a fixed ID determined for a host device in advance; and a user ID a user can determine desirably; wherein the fixed ID and the user ID are integrated with each other whenever the user ID is used so that the device unique ID has a data structure which can be changed whenever the device unique ID is used.

The device unique ID according to the invention includes a device unique ID having a data structure in which the fixed ID and the user ID are integrated based on change field information defining a field of the device unique ID the user ID should be input into.

A secret information LSI according to the invention includes a secret information processing portion for generating a device unique ID; wherein the device unique ID has a data structure in which a fixed ID determined for a host device in advance and a user ID a user can determine desirably whenever the user ID is used are integrated with each other so that the data structure can be changed whenever the device unique ID is used.

The secret information LSI according to the invention includes a secret information LSI in which the secret information processing portion integrates the fixed ID with the user ID based on change field information so as to generate the device unique ID, the change field information defining a field of the device unique ID the user ID should be input into.

The secret information LSI according to the invention has a secret information processing function in which the fixed ID determined for the host device in advance and the user ID the user can determine desirably are integrated, and a device unique ID is generated based on the change field information. Accordingly, protection of the device unique ID can be enhanced, and illegal access can be prevented.

A host device according to the invention includes the secret information LSI.

The host device according to the invention includes a host device further including: a decryption circuit for decrypting an encrypted fixed ID; a storage portion for storing the decrypted fixed ID; an I/F for inputting the user ID the user can determine desirably; and a secret information processing portion by which the fixed ID is read from the storage portion, and the fixed ID and the user ID input through the I/F are integrated to generate a device unique ID.

The host device according to the invention includes a host device further including an encryption circuit for encrypting the device unique ID to thereby generate an encrypted device unique ID.

The host device according to the invention includes a host device further including an authentication key generating circuit for generating an authentication key based on mutual authentication between the host device and the target device.

The LSI according to the invention includes an LSI further including a storage area for storing encrypted change field information.

The host device according to the invention includes a host device further including an external device I/F through which the user ID can be acquired from an external device when the device unique ID is registered, replaced, updated or changed.

The host device according to the invention includes a host device further including an external device I/F through which the change field information can be input from the external device.

The host device according to the invention includes a host device further including a determination circuit for determining the number of times with which the device unique ID has been changed.

A recording medium according to the invention is a recording medium with an authentication function used in the host device.

A portable terminal having a recording medium according to the invention includes a secret information processing function and an authentication function.

In a method for distributing contents using the method according to the invention, a fixed ID determined for the host device in advance and a user ID the user can determine desirably are integrated, and a device unique ID is generated based on change field information. Accordingly, protection of the device unique ID can be enhanced, and illegal access can be prevented.

A database according to the invention accumulates contents distributed by the contents distributing method. Accordingly, protection of the device unique ID can be enhanced, and illegal access can be prevented.

The user in this document means not a final customer but a maker manufacturing host devices or a shop selling or registering the host devices.

The encryption/decryption in the invention includes both encryption/decryption using a secret key system and a public key system. When the invention is applied to a public key system, it will go well if a secret key is used as a key.

As described above, according to the invention, a fixed ID determined before a host device such as a portable terminal is shipped or replaced is, for example, encrypted in advance and stored in the host device such as the portable terminal. After a user ID such as a phone number is registered from an external device when the host device is shipped or replaced, the fixed ID and the user ID are integrated so that a new device unique ID is generated. Thus, a new device unique ID can be generated whenever a user ID is registered. A device unique key is generated based on the device unique ID. Accordingly, protectability of the device unique ID can be enhanced, and illegal access can be prevented.

### BRIEF DESCRIPTION OF THE DRAWINGS

FIG. 1 is a block diagram showing the overall configuration of a device unique ID changing system.

FIG. 2 is a block diagram showing the overall configuration of the system, focusing on a data flow therein according to Example 1.

FIG. 3 is a flow chart.

FIGS. 4A to 4D are diagrams showing configurations of a device unique ID.

FIG. 5 is a data flow among a host device, a target device and an external device in the flow chart of FIG. 3.

FIG. 6 is a chart showing a data flow of an encrypted device unique ID generating process 207 in the flow chart of FIG. 3 (where change field information is stored in the host device).

FIG. 7 is a chart showing a data flow of the encrypted device unique ID generating process 207 (Example 2) in the flow chart of FIG. 3 (where change field information and a hash value are stored in the host device).

FIG. 8 is a block diagram showing the overall configuration of a system, focusing on a data flow therein according to Example 2 of the invention.

FIG. 9 is a data flow of the encrypted device unique ID generating process 207 (Example 3) in the flow chart of FIG. 3 (where change field information is stored and encrypted in the host device).

FIG. 10 is a chart showing a data flow of the encrypted device unique ID generating process 207 (Example 4) in the flow chart of FIG. 3 (where change field information is acquired from the external device).

FIG. 11 is a data flow of the encrypted device unique ID generating process 207 (Example 5) in the flow chart of FIG. 3 (where change field information is acquired from the external device, a hash value of the change field information is also acquired from the outside, and falsification of the change field information is detected).

FIG. 12 is a data flow of the encrypted device unique ID generating process 207 (Example 6) in the flow chart of FIG. 3 (where encrypted change field information is acquired from the external device).

FIG. 13 is a data flow of the encrypted device unique ID generating process 207 (Example 7) in the flow chart of FIG. 3 (where a hash value of a user ID is acquired from the outside and falsification of the user ID is detected).

FIG. 14 is a data flow of the encrypted device unique ID generating process 207 (Example 8) in the flow chart of FIG. 3 (where an encrypted user ID is acquired from the external device).

FIG. 15 is a block diagram showing the overall configuration of a system, focusing on a data flow therein according to Example 8 of the invention.

FIG. 16 is a data flow of the encrypted device unique ID generating process 207 (Example 9) in the flow chart of FIG. 3 (where the number of times of update is controlled).

FIG. 17 is a data flow of a device unique key generating process 206 (Example 10) in the flow chart of FIG. 3.

FIG. 18 is a block diagram showing a block configuration for contents distribution.

FIG. 19 is a block diagram showing the overall configuration of a system, focusing on a data flow therein according to Example 11 of the invention.

FIG. 20 is a block diagram showing the overall configuration of a system, focusing on a data flow therein according to Example 12 of the invention.

FIG. 21 is a block diagram showing the overall configuration of a system, focusing on a data flow therein according to Example 13 of the invention.

FIGS. 22A to 22D are diagrams showing configurations of a device unique ID according to Embodiment 3 of the invention.

FIG. 23 is a block diagram showing the overall configuration of a system, focusing on a data flow therein according to Example 14 of the invention.

### DESCRIPTION OF THE PREFERRED EMBODIMENTS

### Embodiment 1

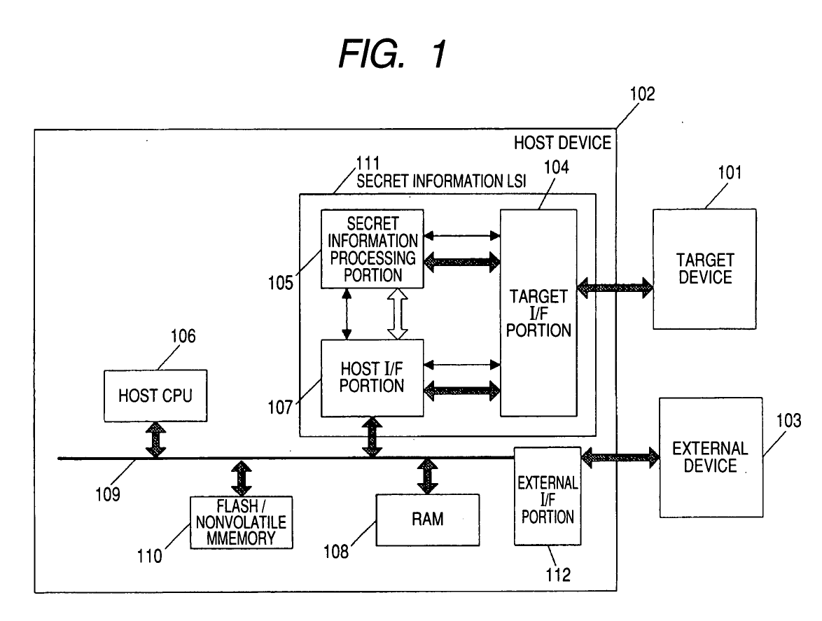

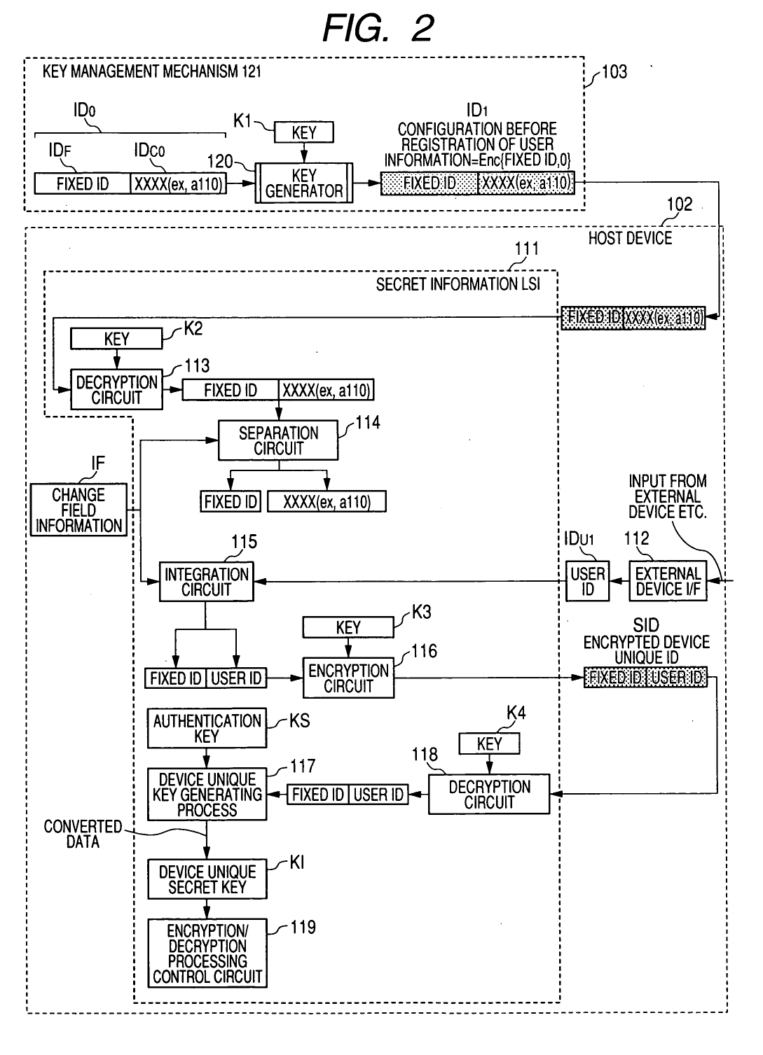

Embodiment 1 which is the best mode for carrying out the invention will be described below. In Embodiment 1, a device unique key generating system as an embodiment of the invention will be described. FIG. 1 shows the overall configuration of a device unique ID changing system constituted by a host device, a target device and an external device. FIG. 2 shows the overall configuration of an example of this system (corresponding to undermentioned Example 1), focusing on a data flow therein.

The target device 101 is a memory card represented by an SD card. When a host device intends to change a device unique ID, the target device 101 performs an authentication process between the target device and the host device. When the target device 101 fails in authentication, the target device 101 is not allowed to generate a key (secret key) serving as an authentication key for decrypting secret information encrypted in advance. With such a configuration, the encrypted secret information can be prevented from being decrypted in an unauthorized host device.

As shown in FIG. 1, the host device 102 is a host device of a portable terminal represented by a portable phone. The host device 102 includes an internal bus 109, a secret information processing portion 105 for encrypting/decrypting secret information in accordance with a predetermined sequence, a host CPU 106 for activating the predetermined sequence for the secret information processing portion 105, a target I/F portion 104 for inputting/outputting data between the host CPU 106 and the target device 101, a host I/F portion 107 for inputting/outputting data between the host CPU 106 and the secret information processing portion 105, an RAM 108 serving as a work area for the host CPU 106 and the secret information processing portion 105 to temporarily store data required for their operation, a nonvolatile memory (FLASH) 110 for storing secret information encrypted in advance, and an external I/F portion 112 to be connected to the external device 103. The secret information processing portion 105, the host I/F portion 107 and the target I/F portion 104 constitute a secret information LSI 111.

The external device 103 is an information management system such as a server. The external device 103 connected to the host device 102 inputs a user ID to the host device 102. When secret information is to be read or written between the target device 101 and the host device 102, the host device 102 has to perform authentication between the target device 101 and the host device 102. Here, in FIG. 2 showing the overall configuration of the system, a key management mechanism 121 is also provided in the external device 103. In the key management mechanism 121, a key generator 120 encrypts a device unique ID (ID₀) with a key K1 to thereby generate an encrypted device unique ID (ID₁). The device unique ID (ID₀) is constituted by a fixed ID portion (ID_{F}) and a variable ID information portion (ID_{c0}).

The key management mechanism 121 is designed to give key information to a key K2 of the secret information LSI 111 of the host device 102 in advance. The key information serves to decrypt this encrypted device unique ID (ID₁). When authentication of the key K2 is approved in the secret information LSI 111 of the host device 102, a decryption circuit 113 decrypts the encrypted device unique ID (ID₁) with the key K2 so as to acquire the device unique ID (ID₀) constituted by the fixed ID portion (ID_{F}) and the variable ID information portion (ID_{c0}). A separation circuit 114 separates this device unique ID into the fixed ID portion (ID_{F}) and the variable ID information portion (ID_{c0}). On this occasion the separation circuit 114 extracts only the fixed ID portion (ID_{F}) while leaving behind the variable ID information portion (ID_{c0}) entirely filled with “0”. Further, the encrypted device unique ID (SID) output from the secret information LSI is input into the secret information LSI again and decrypted by a decryption circuit 118.

When the authentication succeeds thus, the host device 102 reads secret information from the target device 101 through the target I/F portion 104. The host device 102 uses the secret information decrypted by the secret information processing portion 105. Although the secret information processing portion 105 is activated to operate by the host CPU 106, the secret information processing portion 105 is hidden hardware. When the secret information processing portion 105 is activated, the secret information processing portion 105 performs only a predetermined sequence in which security is secured or less security is required.

Here, an integration circuit 115 integrates change field information IF, a user ID (IDᵤ₁) and the fixed ID portion (ID_{F}) to thereby form a device unique ID (ID₁). The change field information I_{F} is built in the host device 102 in advance. The user ID (IDᵤ₁) is input from the external device 103 through the external I/F portion 112. The fixed ID portion (ID_{F}) is extracted by the separation circuit 114. The device unique ID (ID₁) obtained thus is encrypted with a key K3 so that an encrypted device unique ID (SID₁) is obtained.

Further, the encrypted device unique ID (SID₁) obtained thus is decrypted with a key K4 again by the decryption circuit 118 so that a device unique key (device unique secret key) KI is generated by a device unique key generation processing circuit 117 again. The reference numeral 119 designates an encryption/decryption processing control circuit.

Examples of the host device 102 include communicatable portable music player/portable audio player serving as a portable terminal, a network connected portable game machine and a portable phone. Examples of the target device 101 include a memory card (SD card) with an authenticatable copyright protection function, a DVD (DVDRAM) with a copyright protection function and a hard disk with a copyright protection function. Examples of the external device 103 include an information management system such as a server and a phone number registration machine.

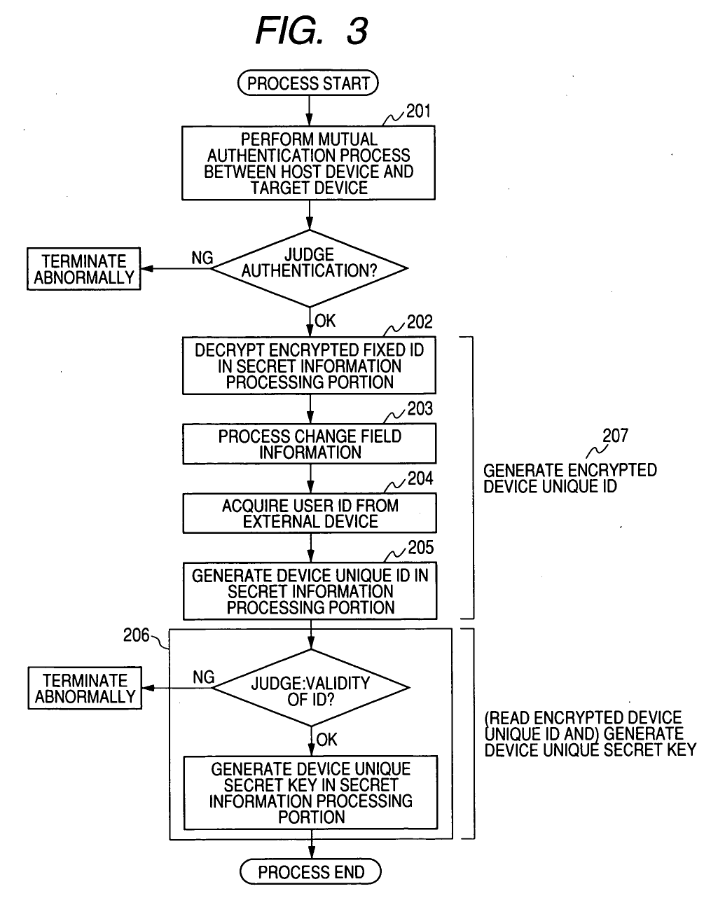

FIG. 3 is a flow chart of a process for acquiring a user ID from the external device, updating a device unique ID, and generating a device unique secret key in the device unique ID changing system shown in FIGS. 1 and 2.

First, in a mutual authentication processing step 201 between the host device and the target device, it is determined whether the host device is an unauthorized device or not. When the mutual authentication succeeds here, an encrypted fixed ID is decrypted with a key (K2 in FIG. 2) in an encrypted fixed ID decryption processing step 202. When the mutual authentication is unsuccessful, the sequence is terminated abnormally.

Then, a change field information processing step 203 is executed. This change field information processing step 203 is a process for handing over designated change field information to a device unique ID generating step 205. In a user ID externally acquiring step 204, a user ID is acquired from the external device and stored in the host device 102.

Further, in the device unique ID generating step 205, the pieces of information obtained in the encrypted fixed ID decryption processing step 202, the change field information processing step 203 and the user ID externally acquiring step 204 are integrated so that a device unique ID is generated.

When the device unique ID is generated thus, a device unique secret key is generated in a device unique secret key generating step 206 using the device unique ID generated in the device unique ID generating step 205. This secret key will be used as a key for hiding information.

When the device unique ID is set illegally, the sequence is terminated abnormally.

Here, the keys K1 to K4 shown in FIG. 2 may be all the same. Alternatively, different keys may be used for a set of the k eys K1 and K2 and a set of the keys K3 and K4 respectively. An authentication key Ks and a device unique key KI are updated and changed whenever processing is performed.

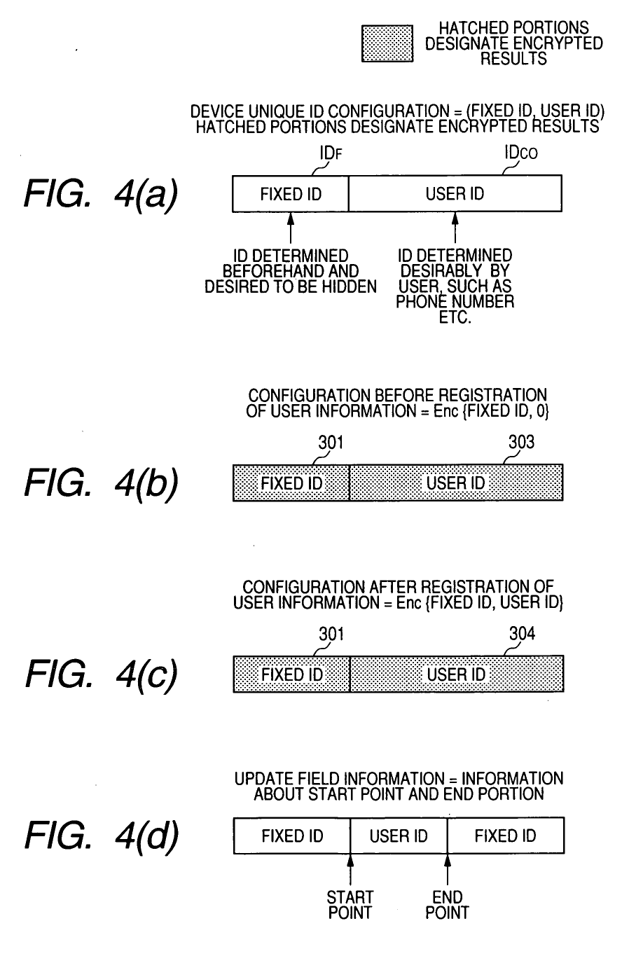

FIGS. 4A to 4D are explanatory diagrams showing configurations of the device unique ID and the change field information. As shown in FIG. 4A, the device unique ID is roughly constituted by two IDs, that is, a fixed ID 301 and a user ID 302. The fixed ID 301 is secret information determined before the host device is registered or replaced. The user ID is user-dependent information such as a phone number. The user ID is an ID which can be changed when the host device is registered or replaced.

As shown in FIG. 4B, a device unique ID before registration of a user ID has a configuration in which a fixed ID 301 and a user ID 303 are encrypted. The field of the user ID 303 set at the time of registration is defined as “0”. As shown in FIG. 4C, the device unique ID after registration of the user ID has a configuration in which the fixed ID 301 and a user ID 304 are encrypted.

Change field information defines a field of the device unique ID in which the user ID should be put. For example, as shown in FIG. 4D, fields of the device unique ID are formed to indicate a start point and an end point of the user ID. For example, assume that an a-th bit and a b-th bit from the head of the device unique ID are the start point and the end point of the user ID respectively. In this case, the change field information is (a, b). In the change field information, the same data as the fixed ID may be placed repeatedly before and after the user ID or the user ID may be inserted into the field of the fixed ID. When the fields are changed thus based on the change field information, a large number of device unique IDs can be generated in accordance with the layout of the fixed ID and the user ID. Thus, a device unique ID which is extremely complicated and is hardly decrypted can be obtained so that the protectability of the device unique ID can be enhanced greatly.

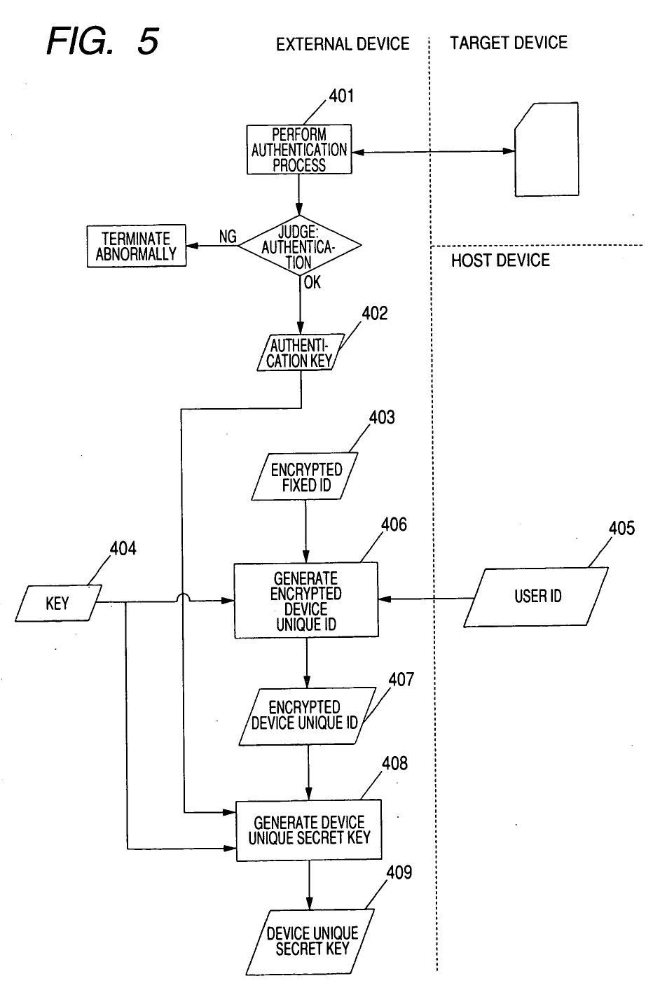

FIG. 5 shows a data flow among the host device, the target device and the external device in the flow chart of FIG. 3. An authentication processing step 401 is performed between the host device and the target device. When the mutual authentication succeeds, an authentication key 402 which will be required in a device unique secret key generating step 408 is generated in the secret information processing portion 105 in FIG. 1. On the other hand, when the mutual authentication is unsuccessful so that the host device is regarded as unauthorized, the sequence is terminated abnormally.

The host device generates a device unique ID from an encrypted fixed ID 403 acquired internally from the host device and a user ID 405 acquired from the external device, and encrypts the device unique ID with a key so as to generate an encrypted device unique ID (encrypted device unique ID generating step 406). This encrypted device unique ID is stored in a storage portion of the host device. The encrypted device unique ID is decrypted with a key 404 by the secret information processing portion of the host device so that a device unique secret key is generated by use of the authentication key 402 (Step 408). Then, this device unique key (device unique secret key) 409 is stored in the host device.

### EXAMPLE 1

(Encrypted Device Unique ID Generating Process 1)

Processes will be described below in detail as examples of the invention.

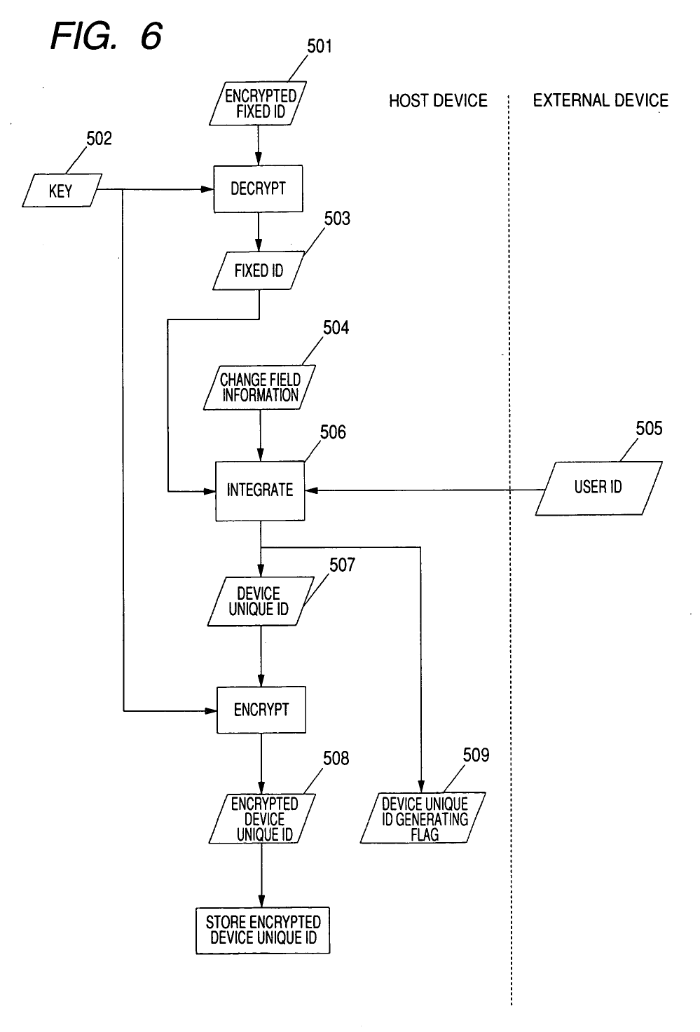

FIG. 6 shows data flow (1) of Example 1 of an encrypted device unique ID generating process 207 in the flow chart of FIG. 3. FIG. 6 represents a method for acquiring only a user ID from the external device while providing change field information in the host device in advance. The overall configuration of this system is illustrated in detail in FIG. 2.

The host device 102 has an encrypted fixed ID and a key (502) for decrypting the encrypted fixed ID. When the host device retrieve the encrypted fixed ID stored in the FLASH 110 in FIG. 1, the host device uses the secret information processing portion 105 in FIG. 1 to decrypt the encrypted fixed ID with the key so as to obtain a fixed ID. The fixed ID obtained thus is integrated with change field information acquired from the host device and a user ID acquired from the external device so that a device unique ID is generated. This device unique ID is stored in the secret information processing portion 105 of the host device.

Since the change field information is plain text, the change field information is stored in the secret information processing portion 105 in the secret information LSI 111 in FIG. 1.

Further, the generated device unique ID and a device unique ID generating flag are stored in the secret information processing portion 105. Here, the generated device unique ID is encrypted with a key by the secret information processing portion 105 in FIG. 1 so that an encrypted device unique ID is obtained. The encrypted device unique ID obtained thus is stored in the FLASH 110.

Here, the key 502 used to decrypt the encrypted fixed ID and the encrypted change field information does not have to be the same as the key 502 used to encrypt the device unique ID. In addition, the fixed ID or the change field information does not have to be encrypted as long as access thereto from any unauthorized external device or the like can be blocked.

In FIG. 6, the key 502, the fixed ID 503, the change field information 504, the device unique ID 507 and the device unique ID generating flag 509 are stored in the secret information processing portion 105. The encrypted fixed ID 501, the change field information 504 and the encrypted device unique ID 508 are stored in the FLASH 110. The user ID 505 acquired from the external device is stored in the RAM 108.

In FIG. 6, the encrypted fixed ID 501 and the key 502 are acquired, and the encrypted fixed ID is decrypted with this key so that the fixed ID 503 is obtained. On the other hand, the change field information 504 is taken out, and the decrypted fixed ID obtained in Step 503, the change field information 504 and the user ID 505 acquired from the external device are integrated (Step 506). Thus, the device unique ID 507 is generated and the device unique ID generating flag 509 is generated.

The device unique ID 507 is encrypted with the key 502 by the host device so that the encrypted device unique ID is obtained (Step 508). This encrypted device unique ID is stored in the host device. The encrypted fixed ID, the change field information and the encrypted device unique ID are stored in the FLASH 110. The user ID 505 acquired from the external device is stored in the RAM 108.

According to the encrypted device unique ID generating process in this Example, only the user ID is input from the external device while the change field information is provided in the host device in advance. Thus, procedure and management are simplified. In addition, since the change field information is plain text, there is an advantage that it is not necessary to decrypt the change field information. When priority is given to the confidentially of the change field information, the change field information may be stored in the secret information LSI.

### EXAMPLE 2

(Encrypted Device Unique ID Generating Process 2)

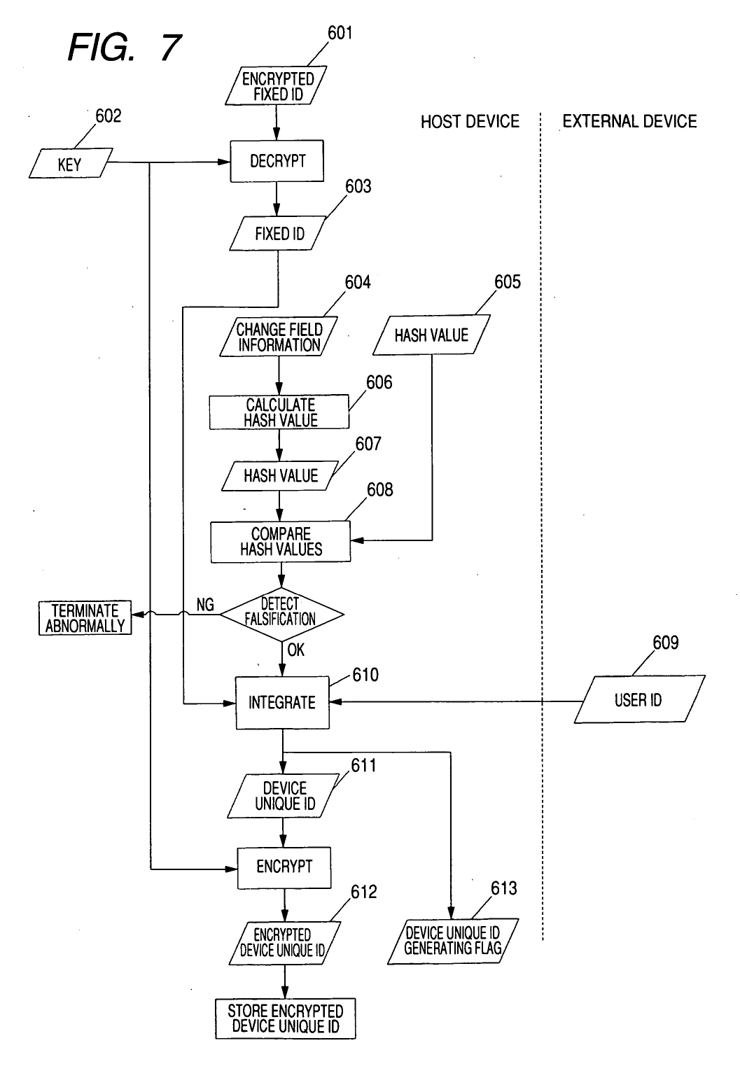

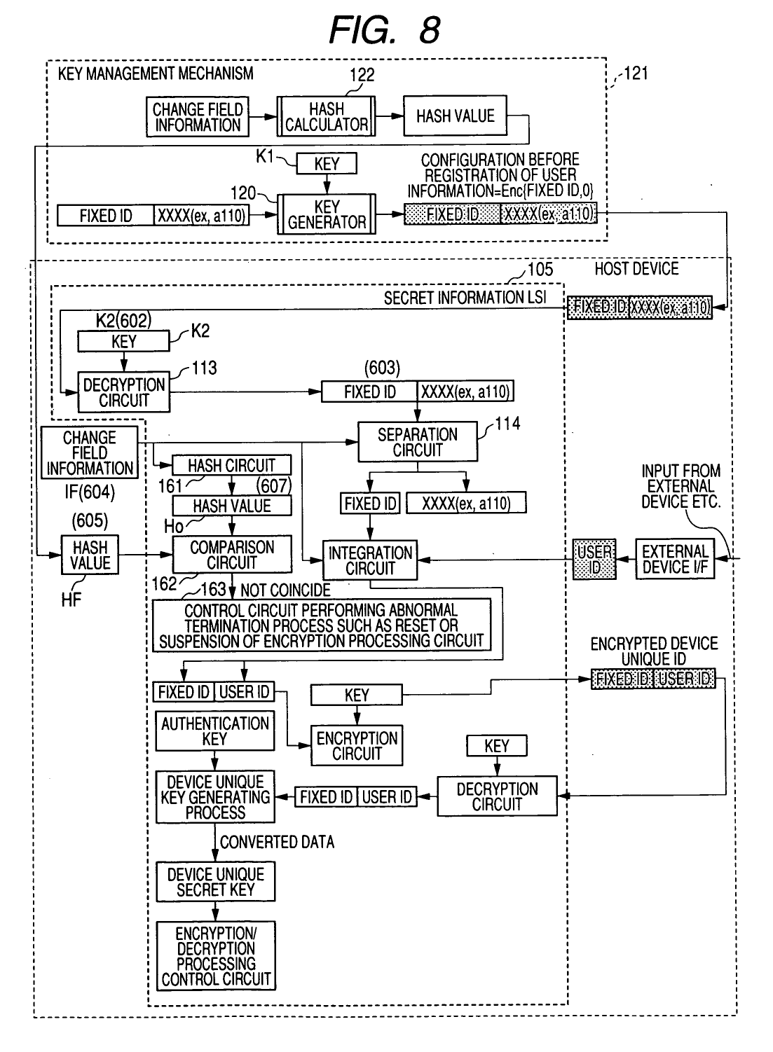

FIG. 7 shows a data flow (Example 2) of the encrypted device unique ID generating process 207 in the flow chart of FIG. 3. FIG. 7 represents a method for acquiring only a user ID from the external device while providing change field information and a hash value in the host device in advance. The overall configuration of this system is illustrated in detail in FIG. 8. FIG. 8 is the same as the block diagram of the overall configuration (FIG. 2) of the system used in Example 1, except that a hash calculator 122 is provided in the key management mechanism 121. Here, the change field information is stored as raw data in the storage portion (FLASH 110) of the host device. On the other hand, a hash value H_{F} (605) generated by the hash calculator 122 of the key management mechanism 121 is embedded in the host device. The hash value H_{F} (605) is compared with a hash value H₀ (607) calculated from the change field information stored in the FLASH 110 (comparison step 608). Thus, falsification in the change field information can be found and prevented.

As shown in FIG. 8, the host device decrypts an encrypted fixed ID 601 with a key K2 (602). On the other hand, a hash value H_{F} (605) of change field information 604 is calculated by the hash calculator 122 provided in the key management mechanism 121, and stored in the storage portion of the host device. In the secret information processing portion of the host device, a hash value H₀ (607) calculated from plain text of the change field information stored in the FLASH 110 is compared with the hash value calculated in the key management mechanism 121. Thus, it is checked whether the change field information has been falsified or not. The host device reads an encrypted fixed ID stored in the FLASH 110 in FIG. 1, and uses the secret information processing portion 105 in FIG. 1 to decrypt the encrypted fixed ID with a key so as to obtain a fixed ID. The fixed ID obtained thus is stored in the secret information processing portion.

That is, as shown in FIG. 7, the host device has the key 602 used to decrypt the encrypted fixed ID 601 stored in the host device and to encrypt a device unique ID 611, the raw change field information 604, and the hash value 605 calculated in the key management mechanism 121 in advance. When the host device reads the encrypted fixed ID 601 stored in the FLASH 110 in FIG. 1, the secret information processing portion 105 in FIG. 1 decrypts the encrypted fixed ID 601 with the key 602 so as to obtain a fixed ID 603. The host device stores the fixed ID 603 in the secret information processing portion 105.

Next, this encrypted device unique ID generating process will be described along the flow chart of FIG. 7.

First, the encrypted fixed ID 601 stored in the FLASH 110 in advance is read. The encrypted fixed ID 601 is decrypted with the key 602 by the secret information processing portion 105 in FIG. 1. Thus, the fixed ID 603 is obtained. In a hash calculation processing step 606, the host device calculates the hash value 607 from the change field information 604 stored in the storage portion of the host device. The host device compares the aforementioned hash value 605 with the hash value 607 in a hash value comparing step 608. When the two values are equal to each other, the host device stores the change field information 604 in the secret information processing portion 105. On the other hand, when the two hash values are different from each other, the sequence is terminated abnormally.

When it is concluded in the hash value comparing step 608 that the hash value 605 and the hash value 607 are equal to each other, the host device acquires a user ID 609 from the external device 103 in FIG. 1 and stores the user ID 609 in the RAM 108. In an integration processing step 610, the host device uses the secret information processing portion 105 in FIG. 1 not only to generate a device unique ID 611 from the decrypted fixed ID 603, the change field information 604 stored in the secret information processing portion 105 and the user ID 609, but also to generate a device unique ID generating flag 613.

The host device stores the generated device unique ID 611 and the generated device unique ID generating flag 613 in the secret information processing portion 105. Here, the host device uses the secret information processing portion 105 in FIG. 1 to encrypt the generated device unique ID 611 with the key 602 so as to obtain an encrypted device unique ID 612. The encrypted device unique ID 612 obtained thus is stored in the FLASH 110.

Here, the key 602 used to decrypt the encrypted fixed ID does not have to be the same as the key 602 used to encrypt the device unique ID. In addition, the fixed ID or the change field information does not have to be encrypted as long as access thereto from any unauthorized external device or the like can be blocked.

In FIG. 7, the key 602, the fixed ID 603, the change field information 604, the device unique ID 611 and the device unique ID generating flag 613 are stored in the secret information processing portion 105. The encrypted fixed ID 601, the change field information 604, the hash value 605 and the encrypted device unique ID 612 are stored in the FLASH 110. The user ID 609 acquired from the external device is stored in the RAM 108.

According to the encrypted device unique ID generating process in this Example, only the user ID is input from the external device while the change field information and the hash value are stored in the host device in advance. Thus, procedure and management are simplified. In addition, when the change field information is falsified from the outside such as an external device, the falsification can be detected.

### EXAMPLE 3

(Encrypted Device Unique ID Generating Process 3)

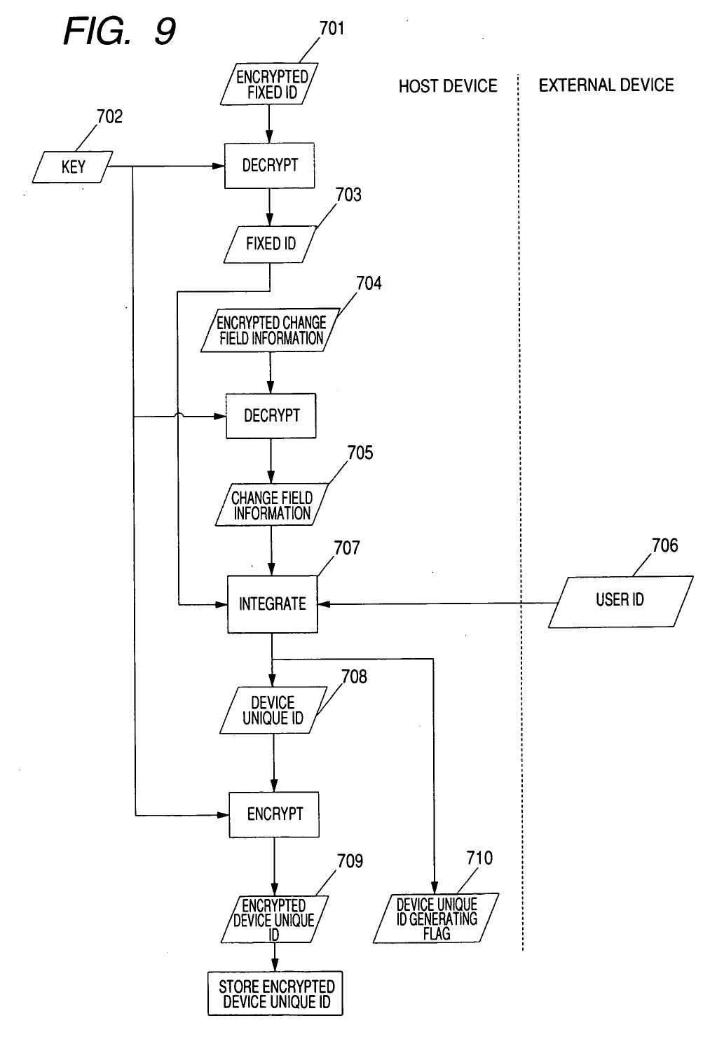

FIG. 9 shows a data flow (Example 3) of the encrypted device unique ID generating process 207 in the flow chart of FIG. 3. FIG. 9 represents a method for acquiring only a user ID from the external device while providing encrypted change field information in the host device in advance.

The host device has an encrypted fixed ID 701, encrypted change field information 704, and a key 702 for decrypting the encrypted fixed ID and the encrypted change field information. When the host device reads the encrypted fixed ID 701 stored in the FLASH 110 in FIG. 1, the host device uses the secret information processing portion 105 in FIG. 1 to decrypt the encrypted fixed ID 701 with the key 702 so as to obtain a fixed ID 703. The fixed ID 703 obtained thus is stored in the secret information processing portion 105.

When the host device then reads the encrypted change field information 704 stored in the FLASH 110 in FIG. 1, the host device uses the secret information processing portion 105 in FIG. 1 to decrypt the encrypted change field information 704 with the key 702 so as to obtain change field information 705. The change field information 705 obtained thus is stored in the secret information processing portion 105.

The host device acquires a user ID 706 from the external device 103 in FIG. 1 and stores the user ID 706 in the FLASH 110. An integration processing step 707 is executed by the secret information processing portion 105 in FIG. 1 so that a device unique ID 708 and a device unique ID generating flag 710 are generated from the fixed ID 703, the change field information 705 and the user ID 706.

The device unique ID 708 and the device unique ID generating flag 710 generated thus are stored in the secret information processing portion 105. Here, the host device uses the secret information processing portion 105 in FIG. 1 to encrypt the generated device unique ID 708 with the key 702 so as to obtain an encrypted device unique ID 709. The encrypted device unique ID 709 obtained thus is stored in the FLASH 110.

Here, the key 702 used to decrypt the encrypted fixed ID and the encrypted change field information does not have to be the same as the key 702 used to encrypt the device unique ID. In addition, the fixed ID or the change field information does not have to be encrypted as long as access thereto from any unauthorized external device or the like can be blocked.

In FIG. 9, the key 702, the fixed ID 703, the change field information 705, the device unique ID 708 and the device unique ID generating flag 710 are stored in the secret information processing portion 105. The encrypted fixed ID 701, the encrypted change field information 704 and the encrypted device unique ID 709 are stored in the FLASH 110. The user ID 706 acquired from the external device is stored in the RAM 108.

According to the encrypted device unique ID generating process in this Example, only the user ID is input from the external device while the encrypted change field information is provided in the host device in advance. Thus, procedure and management are simplified. In addition, even if the encrypted change field information can be read from the outside such as an external device, the change field information can be prevented from being browsed because the change field information is encrypted.

### EXAMPLE 4

(Encrypted Device Unique ID Generating Process 4)

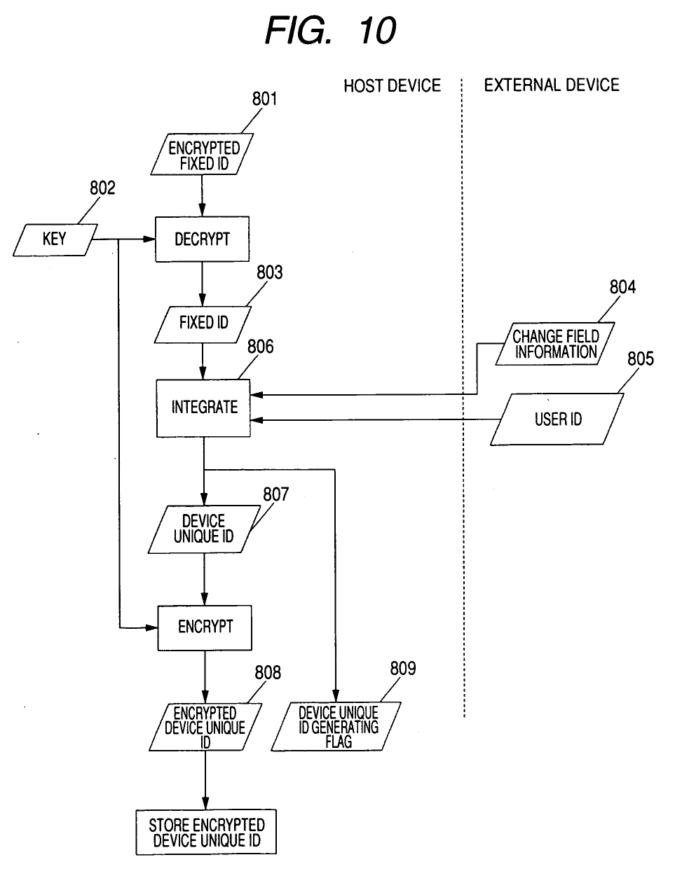

FIG. 10 shows a data flow (Example 4) of the encrypted device unique ID generating process 207 in the flow chart of FIG. 3. FIG. 10 represents a method for acquiring change field information and a user ID from the external device.

The host device has a key 802 for decrypting an encrypted fixed ID 801 and encrypting a device unique ID. When the host device reads the encrypted fixed ID 801 stored in the FLASH 110 in FIG. 1, the host device uses the secret information processing portion 105 in FIG. 1 to decrypt the encrypted fixed ID 801 with the key 802 so as to obtain a fixed ID 803. The fixed ID 803 obtained thus is stored in the secret information processing portion 105.

The host device acquires change field information 804 and a user ID 805 from the external device 103 in FIG. 1 and stores them in the FLASH 110. In an integration processing step 806, the host device uses the secret information processing portion 105 in FIG. 1 to generate a device unique ID 807 and a device unique ID generating flag 809 from the fixed ID 803, the change field information 804 and the user ID 805. The device unique ID 807 and the device unique ID generating flag 809 generated thus are stored in the secret information processing portion 105. Here, the host device uses the secret information processing portion 105 in FIG. 1 to encrypt the generated device unique ID 807 with the key 802 so as to obtain an encrypted device unique ID 808. The encrypted device unique ID 808 obtained thus is stored in the FLASH 110. Here, the key 802 used to decrypt the encrypted fixed ID does not have to be the same as the key 802 used to encrypt the device unique ID.

In FIG. 10, the keys 802, the fixed ID 803, the change field information 804, the device unique ID 807 and the device unique ID generating flag 809 are stored in the secret information processing portion 105. The encrypted fixed ID 801 and the encrypted device unique ID 808 are stored in the FLASH 110. The user ID 805 acquired from the external device and the change field information 804 acquired from the external device are stored in the RAM 108.

According to the encrypted device unique ID generating process in this Example, the change field information can be set from the external device effectively, for example, in setting a plurality of user IDs.

### EXAMPLE 5

(Encrypted Device Unique ID Generating Process 5)

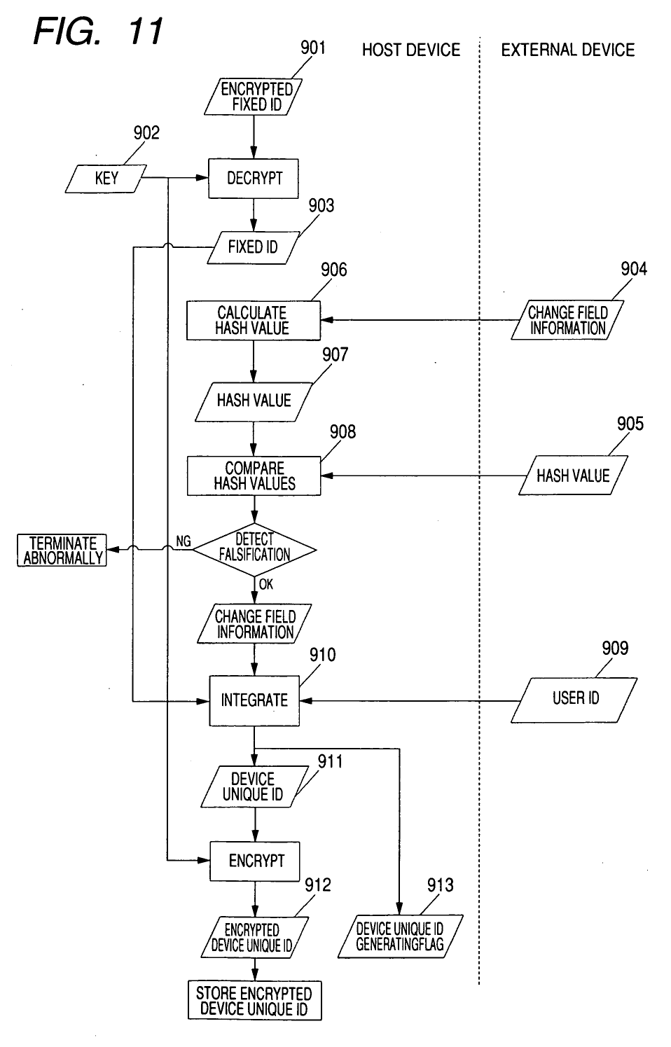

FIG. 11 shows a data flow (Example 5) of the encrypted device unique ID generating process 207 in the flow chart of FIG. 3. FIG. 11 represents a method for acquiring change field information, a hash value of the change field information and a user ID from the external device.

The host device has a key 902 for decrypting an encrypted fixed ID 901 and encrypting a device unique ID. (The key 902 is also used for encryption as will be described later.) When the host device reads the encrypted fixed ID 901 stored in the FLASH 110 in FIG. 1, the host device uses the secret information processing portion 105 in FIG. 1 to decrypt the encrypted fixed ID 901 with the key 902 so as to obtain a fixed ID 903. The fixed ID 903 obtained thus is stored in the secret information processing portion 105.

The host device acquires change field information 904 and a hash value 905 of the change field information from the external device 103. In a step 906 for calculating the hash value of the acquired change field information 904, the host device calculates a hash value 907. In a hash value comparing step 908, the host device compares the hash value 907 with the hash value 905 acquired from the external device. When falsification of the change field information 904 is not detected, the host device stores the change field information 904 in the secret information processing portion 105 in FIG. 1. On the other hand, when falsification of the change field information 904 is detected, the sequence is terminated abnormally.

The host device then acquires a user ID 909 from the external device 103 and stores the user ID 909 in the RAM 108. In an integration processing step 910, the host device uses the secret information processing portion 105 in FIG. 1 to generate a device unique ID 911 and a device unique ID generating flag 913 from the fixed ID 903, the change field information 904 and the user ID 909. The device unique ID 911 and the device unique ID generating flag 913 generated thus are stored in the secret information processing portion 105. Here, the host device uses the secret information processing portion 105 in FIG. 1 to encrypt the generated device unique ID 911 with the key 902 so as to obtain an encrypted device unique ID 912. The encrypted device unique ID 912 obtained thus is stored in the FLASH 110. Here, the key 902 used to decrypt the encrypted fixed ID does not have to be the same as the key 902 used to encrypt the device unique ID.

In FIG. 11, the key 902, the fixed ID 903, the change field information 904 regarded as not falsified, the hash value 907, the device unique ID 911 and the device unique ID generating flag 913 are stored in the secret information processing portion 105. The encrypted fixed ID 901 and the encrypted device unique ID 912 are stored in the FLASH 110. The user ID 909 acquired from the external device, the change field information 904 acquired from the external device and the hash value 905 of the change field information 904 acquired from the external device are stored in the RAM 108.

According to the encrypted device unique ID generating process in this Example, the change field information and the hash value of the change field information are acquired from the external device. It is therefore possible to detect falsification of the change field information.

### EXAMPLE 6

(Encrypted Device Unique ID Generating Process 6)

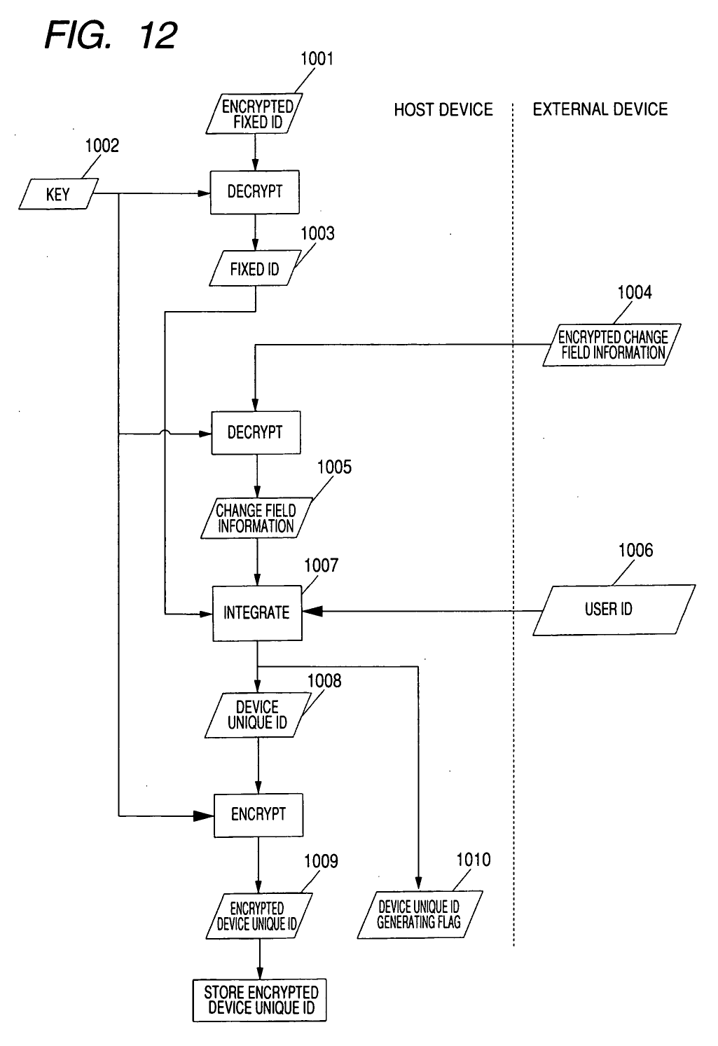

FIG. 12 shows a data flow (Example 6) of the encrypted device unique ID generating process 207 in the flow chart of FIG. 3. FIG. 12 represents a method for acquiring encrypted change field information and a user ID from the external device.

The host device has an encrypted fixed ID 1001, and a key 1002 used to decrypt the encrypted fixed ID and encrypted change field information and to encrypt a device unique ID 1008. When the host device reads the encrypted fixed ID 1001 stored in the FLASH 110 in FIG. 1, the host device uses the secret information processing portion 105 in FIG. 1 to decrypt the encrypted fixed ID 1001 with the key 1002 so as to obtain a fixed ID 1003. The fixed ID 1003 obtained thus is stored in the secret information processing portion 105.

The host device acquires encrypted change field information 1004 from the external device 103 and stores the encrypted change field information 1004 in the RAM 108. When the host device reads the encrypted change field information 1004 stored in the RAM 108, the host device uses the secret information processing portion 105 in FIG. 1 to decrypt the encrypted change field information 1004 with the key 1002 so as to obtain change field information 1005. The change field information 1005 obtained thus is stored in the secret information processing portion 105.

Then, the host device acquires a user ID 1006 from the external device 103 and stores the user ID 1006 in the RAM 108. In an integration processing step 1007, the host device uses the secret information processing portion 105 in FIG. 1 to generate a device unique ID 1008 and a device unique ID generating flag 1010 from the fixed ID 1003, the change field information 1005 and the user ID 1006. The device unique ID 1008 and the device unique ID generating flag 1010 generated thus are stored in the secret information processing portion 105. Here, the host device uses the secret information processing portion 105 in FIG. 1 to encrypt the generated device unique ID 1008 with the key 1002 so as to obtain an encrypted device unique ID 1009. The encrypted device unique ID 1009 obtained thus is stored in the FLASH 110.

Here, the key 1002 used to decrypt the encrypted fixed ID does not have to be the same as the key 1002 used to encrypt the device unique ID. Further, the key used to decrypt the encrypted fixed ID, the key used to encrypt the device unique ID and the key used to decrypt the encrypted change field information may be totally different from one another.

In FIG. 12, the key 1002, the fixed ID 1003, the change field information 1005, the device unique ID 1008 and the device unique ID generating flag 1010 are stored in the secret information processing portion 105. The encrypted fixed ID 1001 and the encrypted device unique ID 1009 are stored in the FLASH 110. The user ID 1006 acquired from the external device and the encrypted change field information 1004 acquired from the external device are stored in the RAM 108.

According to the encrypted device unique ID generating process in this Example, the encrypted change field information and the user ID are acquired from the external device. It is therefore possible to hide the change field information.

### EXAMPLE 7

(Encrypted Device Unique ID Generating Process 7)

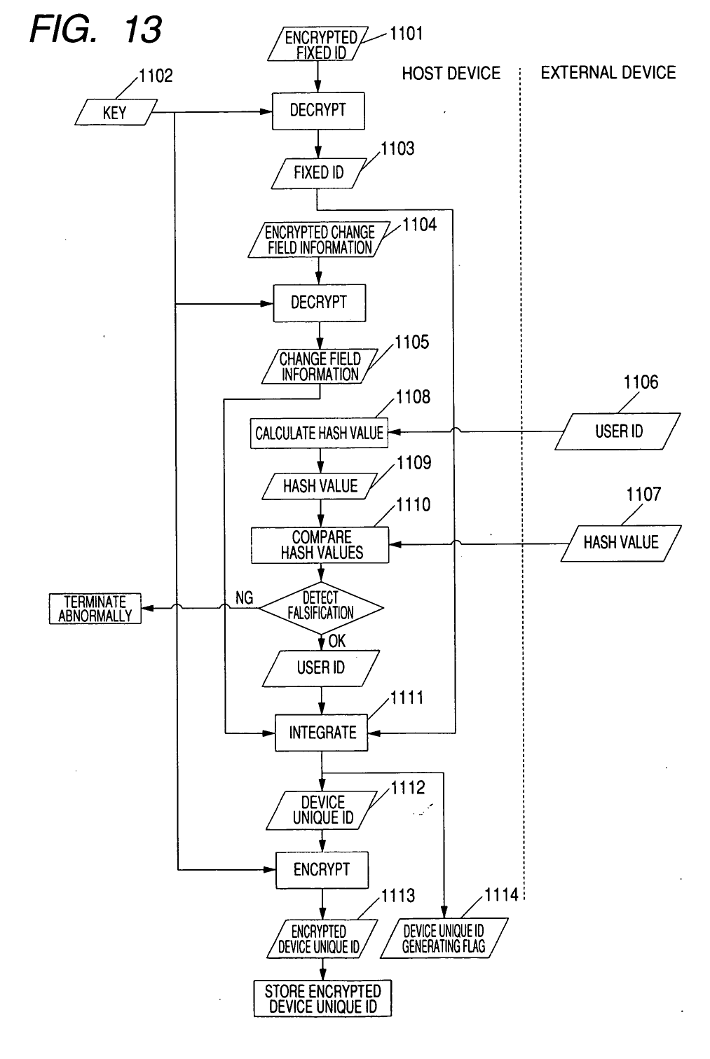

FIG. 13 shows a data flow (Example 7) of the encrypted device unique ID generating process 207 in the flow chart of FIG. 3. FIG. 13 represents a method for acquiring a user ID and a hash value of the user ID from the external device.

The host device has an encrypted fixed ID 1101, and a key 1102 for decrypting encrypted change field information 1104 and the encrypted fixed ID and for encrypting a device unique ID 1112. When the host device reads the encrypted fixed ID 1101 stored in the FLASH 110 in FIG. 1, the host device uses the secret information processing portion 105 in FIG. 1 to decrypt the encrypted fixed ID 1101 with the key 1102 so as to obtain a fixed ID 1103. The fixed ID 1103 obtained thus is stored in the secret information processing portion 105.

When the host device then reads the encrypted change field information 1104 stored in the FLASH 110 in FIG. 1, the host device uses the secret information processing portion 105 in FIG. 1 to decrypt the encrypted change field information 1104 with the key 1102 so as to obtain change field information 1105. The change field information 1105 obtained thus is stored in the secret information processing portion 105.

The host device acquires a user ID 1106 and a hash value 1107 of the user ID from the external device 103. In a step 1108 for calculating the hash value of the acquired user ID 1106, the host device calculates a hash value 1109. In a hash value comparing step 1110, the host device compares the hash value 1107 with the hash value 1109. When falsification of the user ID 1106 is not detected, the host device stores the user ID 1106 in the secret information processing portion 105 in FIG. 1. On the other hand, when falsification of the user ID 1106 is detected, the sequence is terminated abnormally.

In an integration processing step 1111, the host device uses the secret information processing portion 105 in FIG. 1 to generate a device unique ID 1112 and a device unique ID generating flag 1114 from the fixed ID 1103, the change field information 1105 and the user ID 1106. The device unique ID 1112 and the device unique ID generating flag 1114 generated thus are stored in the secret information processing portion 105. Here, the host device uses the secret information processing portion 105 in FIG. 1 to encrypt the generated device unique ID 1112 with the key 1102 so as to obtain an encrypted device unique ID 1113. The encrypted device unique ID 1113 obtained thus is stored in the FLASH 110.

Here, the key 1102 used to decrypt the encrypted fixed ID and the encrypted change field information does not have to be the same as the key 1102 used to encrypt the device unique ID. Further, any one of the methods described with reference to FIGS. 6 to 12 may be used as the method for setting the change field information.

In FIG. 13, the key 1102, the fixed ID 1103, the change field information 1105, the user ID 1106, the device unique ID 1112 and the device unique ID generating flag 1114 are stored in the secret information processing portion 105. The encrypted fixed ID 1101, the encrypted change field information 1104 and the encrypted device unique ID 1113 are stored in the FLASH 110. The user ID 1106 acquired from the external device and the hash value 1107 of the user ID 1106 acquired from the external device are stored in the RAM 108.

According to the encrypted device unique ID generating process in this Example, the user ID and the hash value of the user ID are acquired from the external device. It is therefore possible to detect falsification of the user ID.

### EXAMPLE 8

(Encrypted Device Unique ID Generating Process 8)

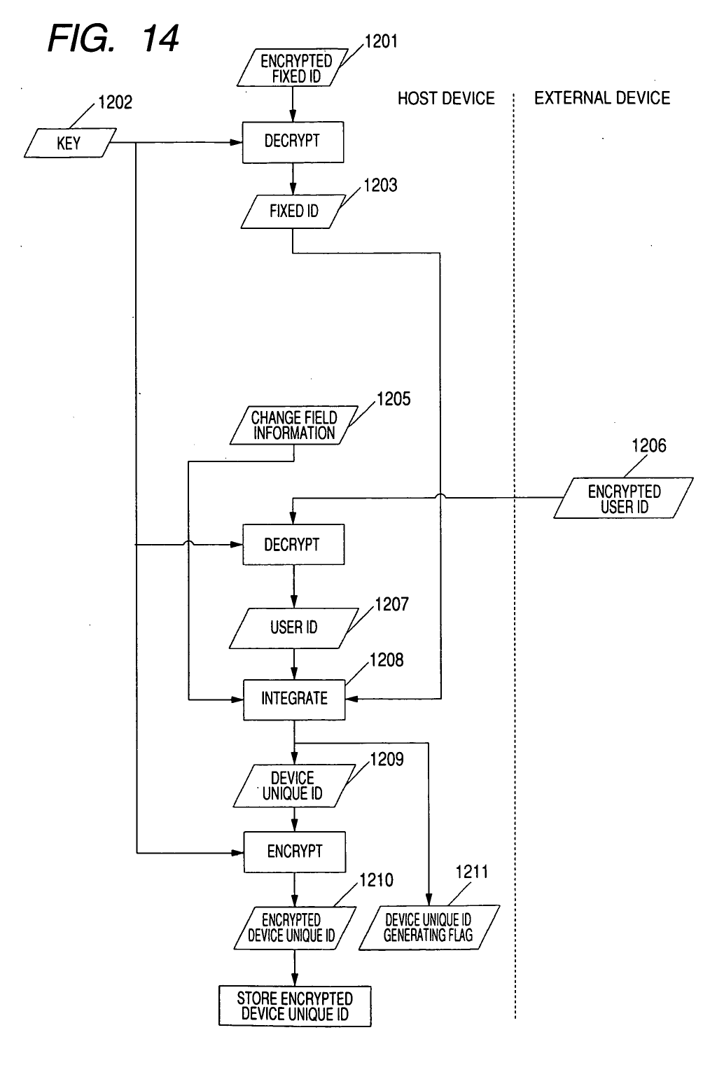

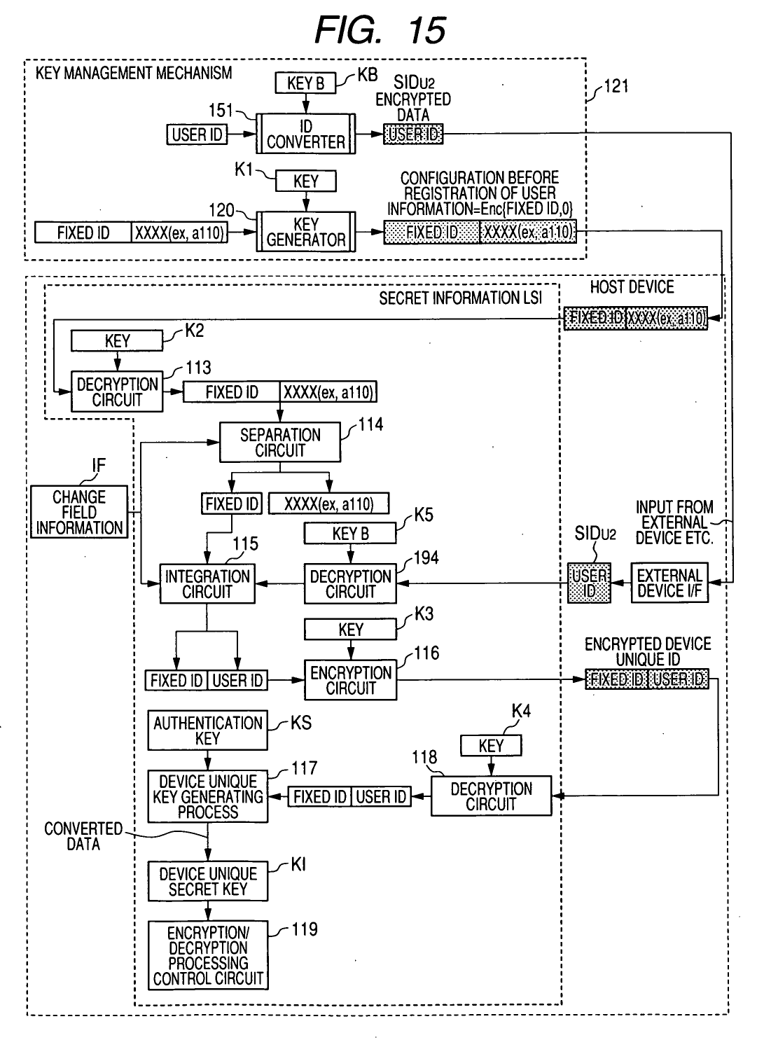

FIG. 14 shows a data flow (Example 8) of the encrypted device unique ID generating process 207 in the flow chart of FIG. 3. FIG. 14 represents a method for acquiring an encrypted user ID from the external device. FIG. 15 is a block diagram showing the configuration of this system. The configuration of FIG. 15 is the same as that of Example 2 in FIG. 8, except that an encrypted user ID is generated from a key KB and a user ID by an ID converter 151 in the key management mechanism 121, and introduced into the external I/F portion of the host device 102, and that a calculated hash value of the change field information is not compared with an embedded one of the change field information in order to prevent falsification but change field information is embedded as plain text in the host device. The other configuration is formed in the same manner as in Example 2 in FIG. 8. Therefore, detailed description thereof will be omitted here. The host device has an encrypted fixed ID 1201, change field information 1205, and a key 1202 for decrypting an encrypted user ID and for encrypting a device unique ID.

When the host device reads the encrypted fixed ID 1201 stored in the FLASH 110 in FIG. 1, the host device uses the secret information processing portion 105 in FIG. 1 to decrypt the encrypted fixed ID 1201 with the key 1202 so as to obtain a fixed ID 1203. The fixed ID 1203 obtained thus is stored in the secret information processing portion 105.

Then, the host device reads the change field information 1205 stored in the FLASH 110 in FIG. 1.

The host device acquires an encrypted user ID 1206 from the external device 103 and stores the encrypted user ID 1206 in the RAM 108. When the host device reads the encrypted user ID 1206 stored in the RAM 108, the host device uses the secret information processing portion 105 in FIG. 1 to decrypt the encrypted user ID 1206 with the key 1202 so as to obtain a user ID 1207. The user ID 1207 obtained thus is stored in the secret information processing portion 1205.

In an integration processing step 1208, the host device uses the secret information processing portion 105 in FIG. 1 to generate a device unique ID 1209 and a device unique ID generating flag 1211 from the fixed ID 1203, the change field information 1205 and the user ID 1207. The device unique ID 1209 and the device unique ID generating flag 1211 generated thus are stored in the secret information processing portion 105. Here, the host device uses the secret information processing portion 105 in FIG. 1 to encrypt the generated device unique ID 1209 with the key 1202 so as to obtain an encrypted device unique ID 1210. The encrypted device unique ID 1210 obtained thus is stored in the FLASH 110.

Here, the key 1202 used to decrypt the encrypted fixed ID does not have to be the same as the key 1202 used to encrypt the device unique ID. Further, any one of the methods described with reference to FIGS. 6 to 12 may be used the method for setting the change field information.

In FIG. 14, the key 1202, the fixed ID 1203, the change field information 1205, the user ID 1207, the device unique ID 1209 and the device unique ID generating flag 1211 are stored in the secret information processing portion 105. The encrypted fixed ID 1201, the encrypted change field information 1205 and the encrypted device unique ID 1210 are stored in the FLASH 110. The encrypted user ID 1206 acquired from the external device is stored in the RAM 108.

According to the encrypted device unique ID generating process in this Example, the encrypted user ID is acquired from the external device. It is therefore possible to hide the user ID.

### EXAMPLE 9

(Encrypted Device Unique ID Generating Process 9)

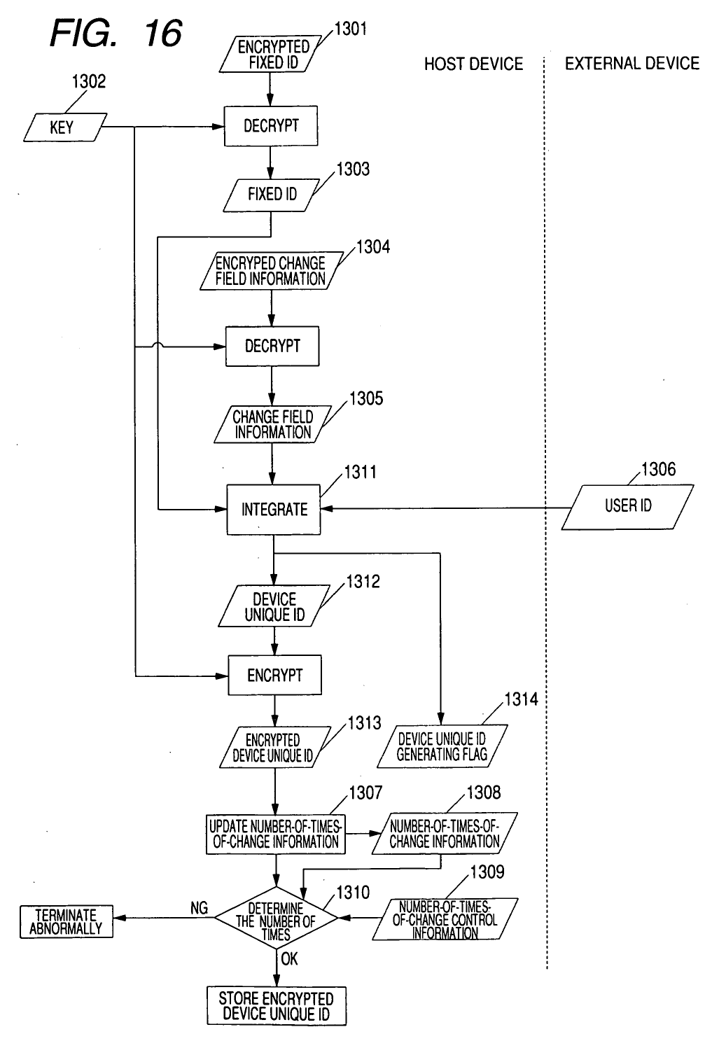

FIG. 16 shows a data flow (Example 9) of the encrypted device unique ID generating process 207 in the flow chart of FIG. 3. FIG. 16 represents a method for controlling the number-of-times-of-change. The host device has an encrypted fixed ID 1301, encrypted change field information 1304, a key 1302 for decrypting the encrypted fixed ID and the encrypted change field information and for encrypting a device unique ID, and number-of-times-of-change control information 1309.

When the host device reads the encrypted fixed ID 1301 stored in the FLASH 110 in FIG. 1, the host device uses the secret information processing portion 105 in FIG. 1 to decrypt the encrypted fixed ID 1301 with the key 1302 so as to obtain a fixed ID 1303. The fixed ID 1303 obtained thus is stored in the secret information processing portion 105.

When the host device then reads the encrypted change field information 1304 stored in the FLASH 110 in FIG. 1, the host device uses the secret information processing portion 105 in FIG. 1 to decrypt the encrypted change field information 1304 with the key 1302 so as to obtain change field information 1305. The change field information 1305 obtained thus is stored in the secret information processing portion 105.

The host device acquires an encrypted user ID 1306 from the external device 103 and stores the encrypted user ID 1306 in the RAM 108. In a number-of-times-of-change information updating step 1307, the host device updates number-of-times-of change information 1308. In a number-of-times determining step 1310, the host device compares the number-of-times-of-change information 1308 with number-of-times-of-change control information 1309 set in the host device in advance. When the number-of-times-of-change information 1308 does not exceed the number-of-times-of-change control information 1309, the secret information processing portion 105 in FIG. 1 generates a device unique ID 1312 and a device unique ID generating flag 1314 from the fixed ID 1303, the change field information 1305 and the user ID 1306 in an integration processing step 1311.

The device unique ID 1312 and the device unique ID generating flag 1314 generated thus are stored in the secret information processing portion 105. Here, the host device uses the secret information processing portion 105 in FIG. 1 to encrypt the generated device unique ID 1312 with the key 1302 so as to obtain an encrypted device unique ID 1313. The encrypted device unique ID 1313 obtained thus is stored in the RAM 108. When the number-of-times-of-change information 1308 exceeds the number-of-times-of-change control information 1309 in the number-of-times determining step 1310, the sequence is terminated abnormally.

Here, the key 1302 used to decrypt the encrypted fixed ID and the encrypted change field information does not have to be the same as the key 1302 used to encrypt the device unique ID. Further, any one of the methods described with reference to FIGS. 6 to 14 may be used as the method for setting the change field information and the user ID.

In FIG. 16, the key 1302, the fixed ID 1303, the change field information 1305, the user ID 1306, the device unique ID 1312, the device unique ID generating flag 1314, the number-of-times-of-change control information 1309 and the number-of-times-of-change information 1308 are stored in the secret information processing portion 105. The encrypted fixed ID 1301, the encrypted change field information 1304 and the encrypted device unique ID 1313 are stored in the FLASH 110. The user ID 1306 acquired from the external device is stored in the RAM 108.

According to the encrypted device unique ID generating process in this Example, it is possible to control the number of times with which the device unique ID has been updated.

### EXAMPLE 10

(Device Unique Secret Key Generating Process 1)

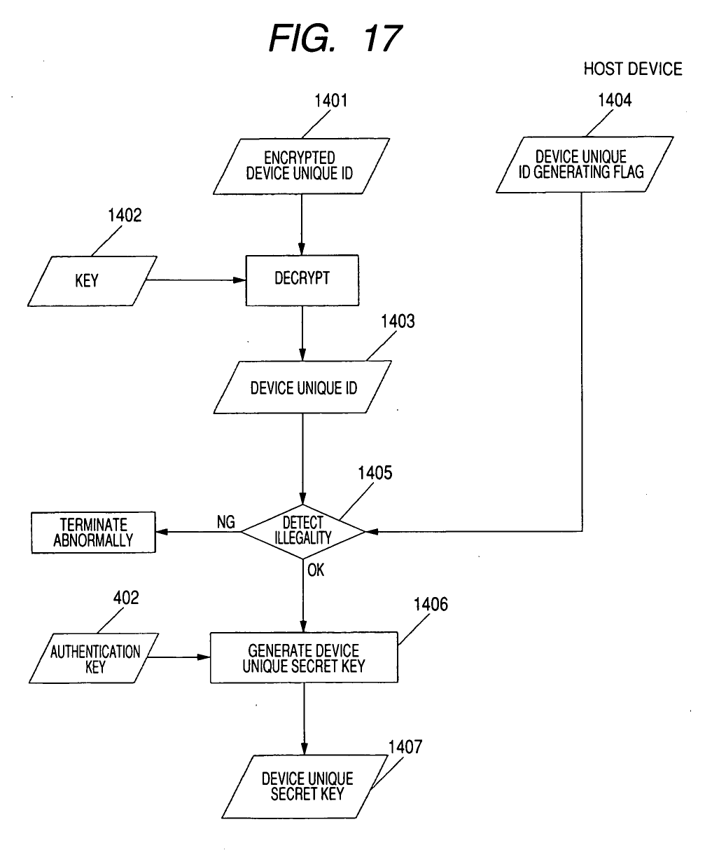

FIG. 17 shows, as Example 10, a data flow (1) of the device unique secret key generating process 206 in the flow chart of FIG. 3. The host device has a key 1402 for decrypting a device unique ID.

An encrypted device unique ID 1401 obtained by any one of the methods described with reference to FIGS. 6 to 16 is read from the FLASH 110 in FIG. 1, and decrypted with the key 1402 by the secret information processing portion 105. Thus, a device unique ID 1403 is obtained. The device unique ID 1403 obtained thus is stored in the secret information processing portion 105.

In an illegality detecting step 1405, it is determined whether there is or not an illegal attempt to generate a device unique secret key from a device unique ID generating flag 1404 and the device unique ID 1403 obtained by any one of the methods described with reference to FIGS. 6 to 16. When there is no illegal attempt, an authentication process is performed between the host device of FIG. 4 and the target device. When the mutual authentication succeeds, an authentication key 402 is generated and bound with the device unique ID 1403 in a device unique secret key generating step 1406. Thus, a device unique secret key 1407 is obtained. The device unique secret key 1407 obtained thus is stored in the secret information processing portion 105.

The host device decrypts contents with the obtained device unique secret key 1407. For example, encrypted contents data received from the external device 103 are decrypted with the device unique secret key 1407 stored in the FLASH 110, and stored in a predetermined contents data storage unit. Thus, a user can use the contents data.

In FIG. 17, the key 1402, the device unique ID 1403, the device unique ID generating flag 1404, the authentication key 1402 and the device unique secret key 1407 are stored in the secret information processing portion 105. The encrypted device unique ID 1401 is stored in the FLASH 110.

According to the device unique secret key generating step in this Example, it is possible to detect an illegal ID. For example, the device unique secret key is not generated when the phone number is not registered.

### EXAMPLE 11

Example 11 of the invention will be described below.

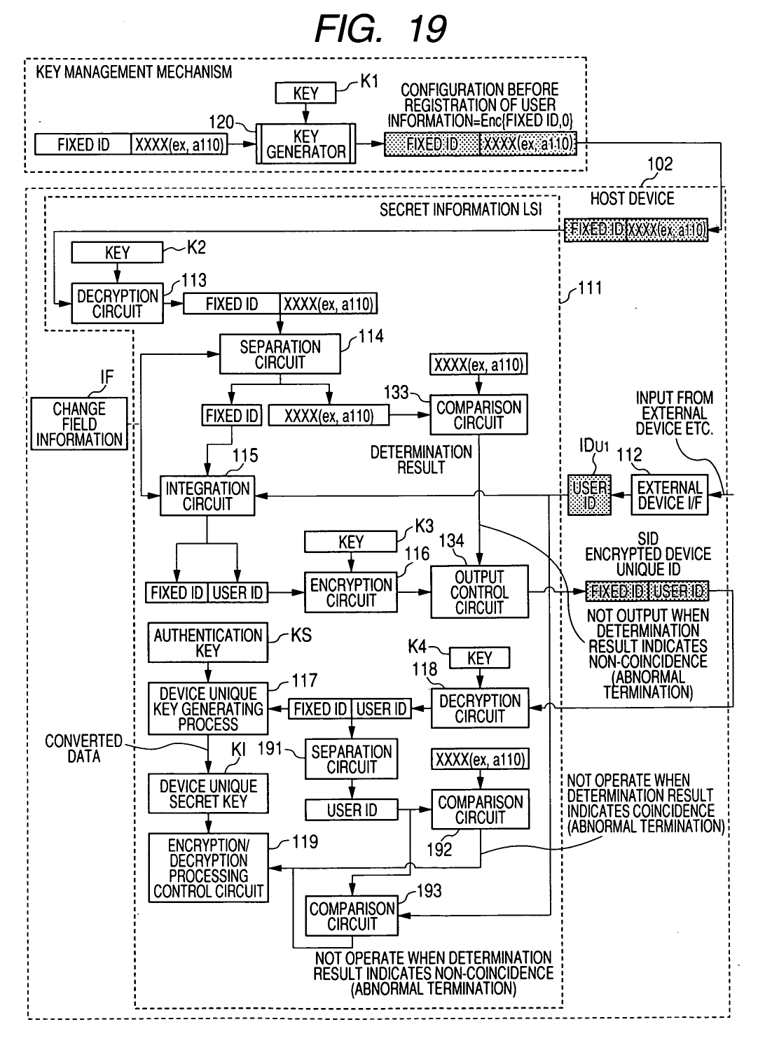

In the system in Example 8 shown in FIG. 15, an encrypted user ID is generated from a key KB and a user ID by the ID converter 151 in the key management mechanism 121 and introduced into the external I/F of the host device 102. In this Example shown in FIG. 19, a raw user ID is input into the host device through the external I/F (112).

That is, as shown in FIG. 19, in Example 11, the secret information processing portion of the host device uses an encryption circuit 116 to encrypt a device unique ID generated by an integration circuit 115 with a key K3, so as to generate an encrypted device unique ID. The secret information processing portion of the host device stores this encrypted device unique ID in the storage portion of the host device through an output control circuit 134. The encrypted device unique ID is input from the storage portion of the host device to the secret information processing portion of the host device through the I/F again. The secret information processing portion of the host device uses a decryption circuit 118 to decrypt the encrypted device unique ID with a key K4 so as to generate the device unique ID to thereby generate a device unique key KI by use of an authentication key KS.

On the other hand, a user ID input from the outside of the host device through the external IF 112 is compared with a user ID portion of the decrypted device unique ID by a comparison circuit 133. When the input user ID does not coincide with the user ID portion, the output control circuit 134 regards the user ID as unauthorized, and suspends a subsequent encryption/decryption process.

Further, the encrypted device unique ID is decrypted by the decryption circuit 118 and separated by a separation circuit 191. A user ID obtained thus is compared with an initial value of the user ID by a comparison circuit 192. When the user ID coincides with the initial value of the user ID, the user ID is regarded as not updated, and the sequence is terminated abnormally. Further, the user ID is compared with a user ID input from the external device by a comparison circuit 193. When the result of the comparison indicates that the user IDs do not coincide with each other, an encryption/decryption process is controlled by a control circuit 119 so as to terminate the sequence abnormally. The configuration on the upstream side of the comparison circuits in FIG. 19 is the same as that in FIG. 2. Constituents the same as those in FIG. 2 are referenced correspondingly and description thereof will be omitted.

When an encrypted fixed ID and a plaintext user ID are input in FIG. 19, a fixed ID and an initial value of the user ID are decrypted with a key K2 in the decryption circuit 113.

Based on change field information IF, the fixed ID and the user ID are integrated by the integration circuit 115. The encrypted device unique ID is decrypted with the key K2 by the decryption circuit 113 and separated into the fixed ID portion and the user ID portion by a separation circuit 114.

The user ID input to the host device in the aforementioned manner and the initial value of the user ID registered in the host device in advance are compared with each other by the comparison circuit 133. The integrated device unique ID is encrypted again with the key K3 by the encryption circuit 116.

When the output of the comparison circuit 133 indicates that the input user ID does not coincide with the initial value of the registered user ID, the output control circuit 134 performs control not to output an encrypted device unique ID (SID).

Otherwise, the output control circuit generates an encrypted device unique ID (SID).

At the same time, the initial value of the decrypted user ID and a value attached to the secret information processing portion in advance are compared with each other by the comparison circuit 192. When the result of the comparison in the comparison circuit 192 indicates that the two values coincide with each other, the encryption/decryption processing control circuit 119 does not output a device unique secret key. Only when the comparison result indicates that the two values do not coincide with each other, the encryption/decryption processing control circuit 119 outputs a device unique secret key. That is, there is fear that an unregistered user ID would be decrypted if the user ID were used as it is. Therefore, it is checked here whether the user ID has been registered or not. Since determination is made based on the comparison with the information of the initial value in the aforementioned manner, security can be further enhanced.

The encrypted device unique ID output when the comparison circuit 133 concludes that the user ID coincides with the initial value of the user ID is then input into the secret information processing portion again and decrypted with the key K4 by the decryption circuit 118. An authentication secret key generated based on mutual authentication between the host device and the target device and a device unique ID are input to a device unique key generation processing circuit 117. Thus, a device unique key (device unique secret key) KI is generated.

In parallel with this, a user ID is separated from the device unique ID generated in the secret information processing portion by the separation circuit 191, and compared with the value attached to the secret information processing portion in advance by the comparison circuit 192. When the comparison result indicates that the separated user ID coincides with the attached value, reset etc. is executed so that a subsequent encryption/decryption process is prevented from being performed. When the comparison result indicates that the separated user ID does not coincide with the attached value, the user ID is regarded as normal, and the subsequent encryption/decryption process is allowed to be performed. Then, a user ID input from the outside is compared with the user ID separated by the separation circuit 191 by a comparison circuit 193. When the comparison result indicates that the two user IDs do not coincide with each other, reset etc. is executed so that a subsequent encryption/decryption process is prevented from being performed. When the comparison result indicates that the two user IDs coincide with each other, the user ID is regarded as normal, and the subsequent encryption/decryption process is allowed to be performed.

### EXAMPLE 12

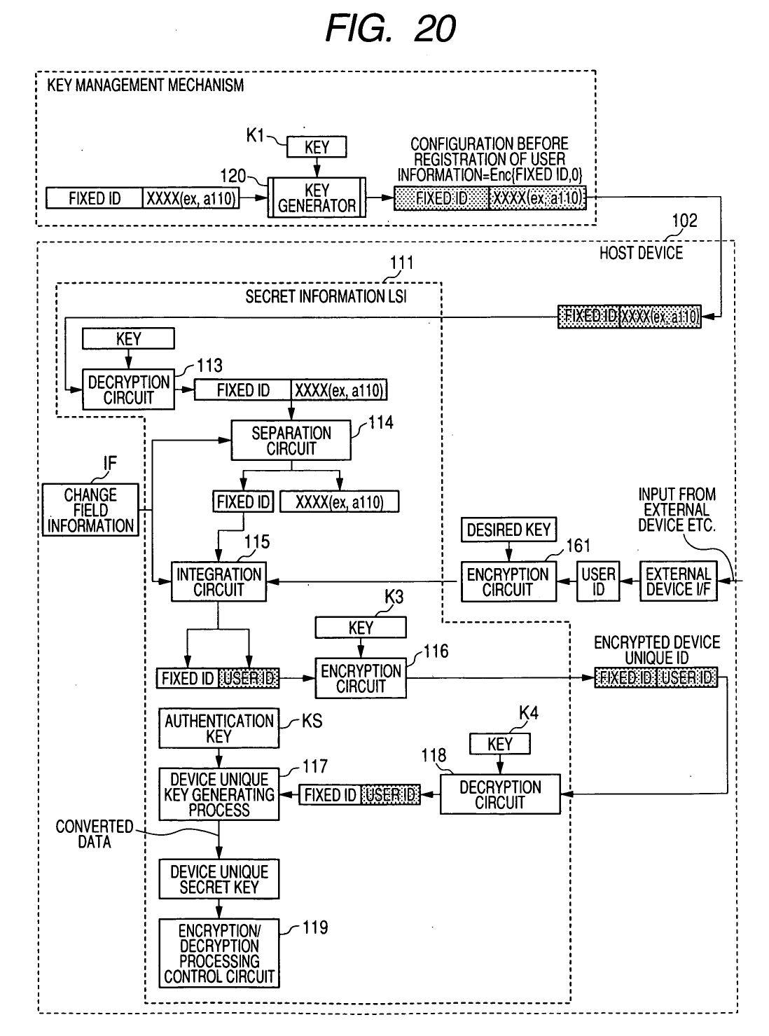

FIG. 20 shows Example 12 of the invention in which a user ID acquired from the external device by the host device is encrypted by an encryption circuit 161 using a desired key, and stored in the outside of the secret information LSI 111, by way of example. FIG. 20 is characterized in that the encrypted user ID input into the secret information LSI is integrated with a fixed ID and change field information by an integration circuit 115. That is, FIG. 20 is characterized in that the secret information processing portion designed to encrypt the aforementioned device unique ID so as to generate an encrypted device unique ID does not decrypt an encrypted user ID input from the outside of the host device through the IF but integrates the encrypted user ID with a fixed ID in the integration circuit 115 by use of change field information so as to generate a device unique ID.

The other configuration is formed in the same manner as that in Example 11. In FIG. 20, constituents similar to and the same as those in FIG. 2 are referenced correspondingly and description thereof will be omitted.

According to this configuration, the user ID is encrypted with a desired key and stored in a hidden state into the outside of the secret information LSI 111. Since the encrypted user ID is read and integrated with the fixed ID and the change field information, the hidden state of the user ID can be kept easily.

Accordingly, even if the user ID is known, the device unique key cannot be generated by use of a raw user ID because the user ID is encrypted by the encryption circuit 161.

### EXAMPLE 13

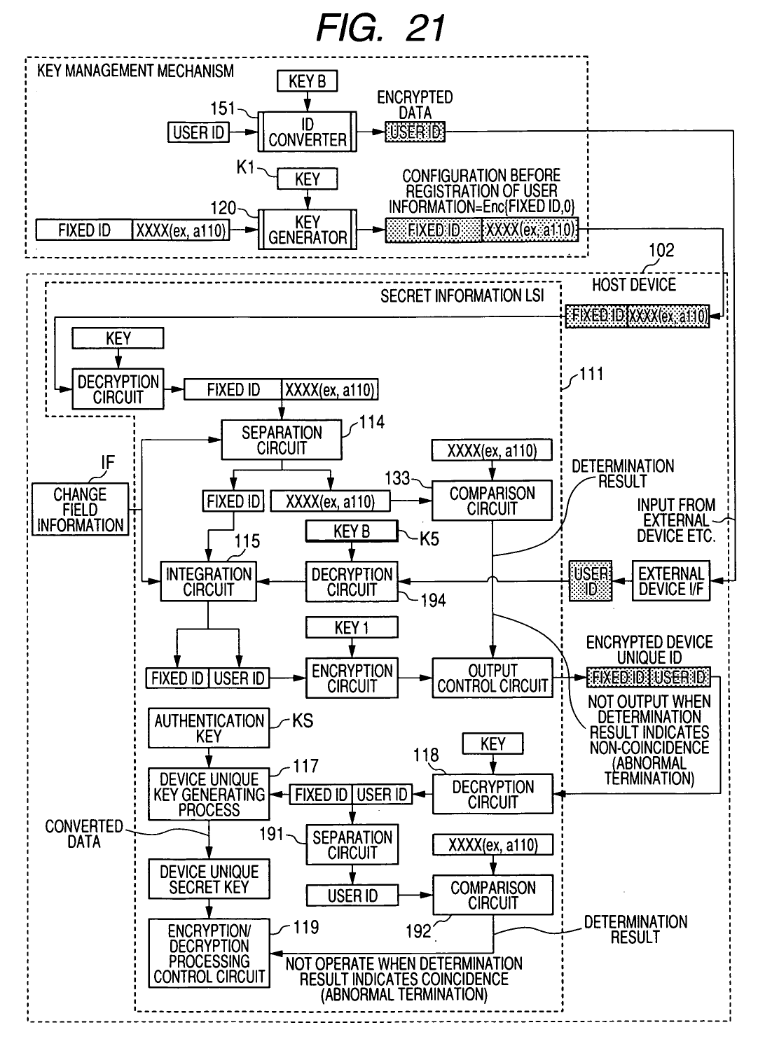

FIG. 21 shows Example 13 of the invention. Example 13 is different from Example 11 in that an encrypted user ID is input. In this manner, input of an unauthorized encrypted device unique ID does not lead to operation. Thus, illegal access can be prevented.

In terms of the circuit configuration, Example 13 is different from Example 11 in that an encrypted user ID is input from the external device to a decryption circuit 194 of the secret information LSI of the host device 102. Here, the user ID encrypted by the ID converter 151 of the key management mechanism is decrypted with a key K5 by a decryption circuit 194 in the secret information LSI of the host device, and integrated with a fixed ID and change field information by an integration circuit 115 in the same manner as in Example 11.

In this manner, the user ID is encrypted so that the user ID can be hidden more surely accordingly.

### Embodiment 2

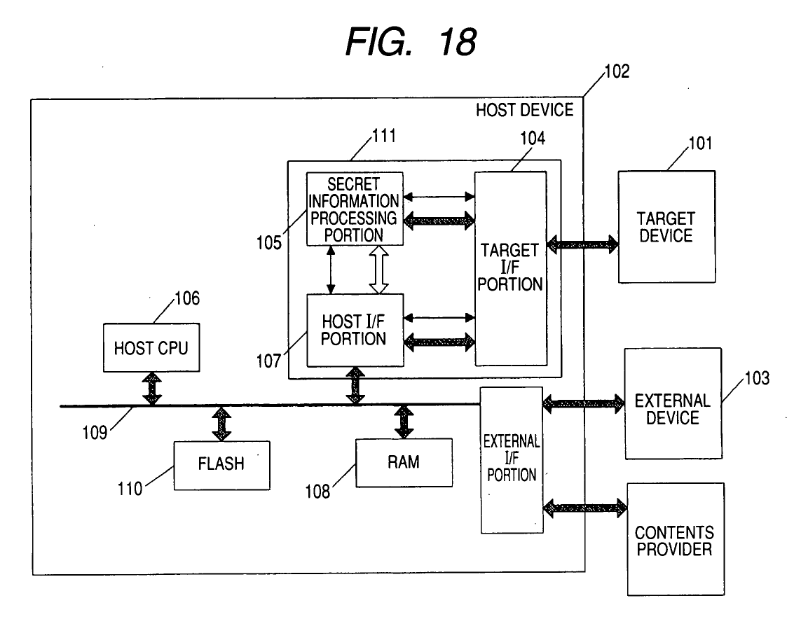

FIG. 18 shows a block configuration for contents distribution in which a host device 102, a target device 101, an external device 103 and a contents provider 113 are provided according to Embodiment 2 of the invention. The contents provider 113 can communicate with an external I/F portion 112 of the host device 102.

According to the embodiment, when the host device 102 downloads a ringing tone etc., a host CPU 106 gives an instruction to a secret information LSI 111 so that the secret information LSI 111 performs data exchange with the contents provider 113 through the external I/F portion 112 in the same manner as data exchange with the target device 101. In this manner, the contents provider 113 can be protected.

FIG. 18 shows the whole outline of data exchange including a key management mechanism. FIG. 18 is correspondent to the encrypted device unique ID generating process (1) in FIG. 6.

### Embodiment 3

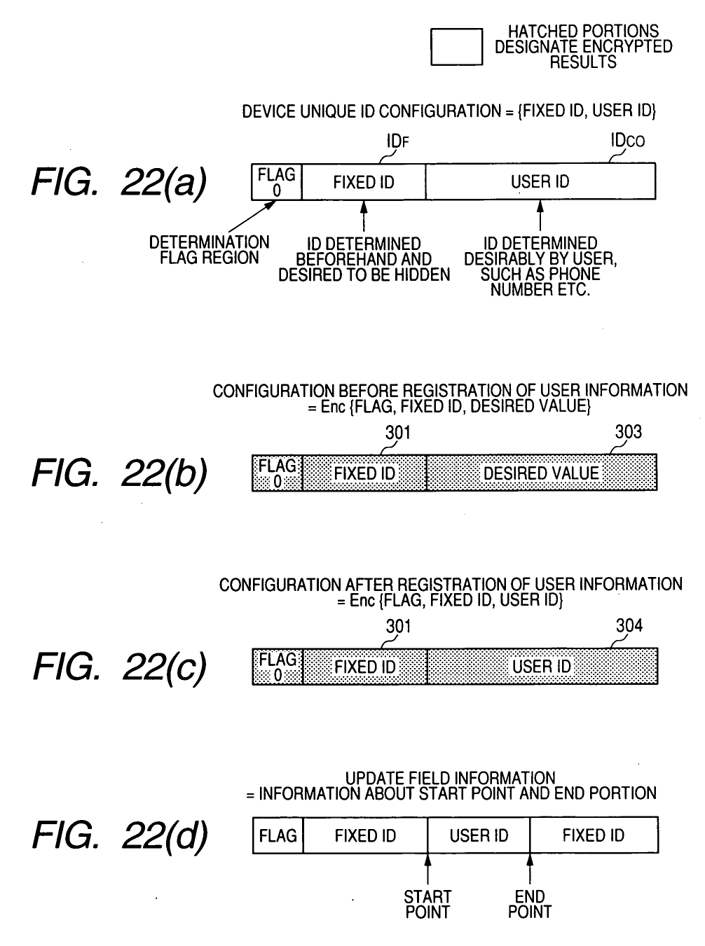

Next, Embodiment 3 of the invention will be described. FIGS. 22A to 22D show configurations of a device unique ID according to Embodiment 3 of the invention. In the aforementioned Embodiment 1, the user ID portion which has not been updated includes all Os. The device unique ID encrypted at the time of generation of the device unique key is decrypted, and the user ID portion is separated from the decrypted device unique ID by the separation circuit. Determination as to whether the user ID portion has been updated correctly or not is based on the determination as to whether the user ID portion includes all Os or not. On the other hand, this embodiment is characterized in that a determination flag as to whether updating has been performed correctly or not is included in a device unique ID. FIGS. 22A to 22D are explanatory views showing configurations of the device unique ID and change field information. The device unique ID is generated by the key management mechanism. As shown in FIG. 22A, the device unique ID includes two IDs (i.e. a fixed ID 301 and a user ID 302) and a flag FLAG 0 added ahead of the fixed ID 301. The other configuration is the same as that in the aforementioned Embodiment 1. That is, the fixed ID 301 is secret information determined before the host device is registered or replaced. The user ID is user-dependent information such as a phone number. The user ID is an ID which can be changed when the host device is registered or replaced.

That is, the device unique ID is roughly constituted by three parts, i.e. a determination flag region, a fixed ID 301 and a user ID 304. When the determination flag region is provided in the device unique ID, it is possible to determine whether the user ID has been updated correctly or not. The determination flag region may contain one bit or a plurality of bits. The determination flag region is used only as a determination flag. The device unique key generating method based on a device unique ID constituted by the fixed ID and the user ID excluding the determination flag region may be used in a device unique key generating process.

As shown in FIG. 22A, the device unique ID is constituted by the two IDs (i.e. the fixed ID 301 and the user ID 302) and the flag FLAG 0 added ahead of the fixed ID 301. The other configuration is the same as that in the aforementioned Embodiment 1. That is, the fixed ID 301 is secret information determined before the host device is registered or replaced. The user ID is user-dependent information such as a phone number. The user ID is an ID which can be changed when the host device is registered or replaced.

The device unique ID is formed by the key management mechanism so that a flag region is provided ahead of a fixed ID. The device unique ID where a user ID has not yet been registered has a configuration in which the fixed ID 301 and a user ID 303 are encrypted as shown in FIG. 22B. In the user ID 303, a user ID field which should be set when a user ID is registered is defined as a desired value. The device unique ID where a user ID has been registered has a configuration in which the fixed ID 301 and a user ID 304 are encrypted as shown in FIG. 22C. When the user ID is registered thus, FLAG 1 is generated.

Change field information defines a field of the device unique ID in which the user ID should be put in the same manner as in the aforementioned embodiment. For example, as shown in FIG. 22D, FLAG is first formed and fields of the device unique ID are then configured to indicate a start point and an end point of the user ID. For example, assume that an a-th bit and a b-th bit from the head of the device unique ID are the start point and the end point of the user ID respectively. In this case, the change field information is (a, b). In the change field information, the same data as the fixed ID may be placed repeatedly before and after the user ID or the user ID may be inserted into the field of the fixed ID. When the fields are changed thus based on the change field information, a large number of device unique IDs can be generated in accordance with the layout of the fixed ID and the user ID. Thus, a device unique ID which is extremely complicated and is hardly decrypted can be obtained so that the protectability of the device unique ID can be enhanced greatly.

The encrypted device unique ID is decrypted when a device unique key is generated. In this event, the flag is checked to determine whether the device unique ID has been updated correctly or not. When the flag has been asserted, the device unique key is generated. When the flag has not been asserted, processing is suspended to prevent the device unique key from being generated.

### EXAMPLE 14

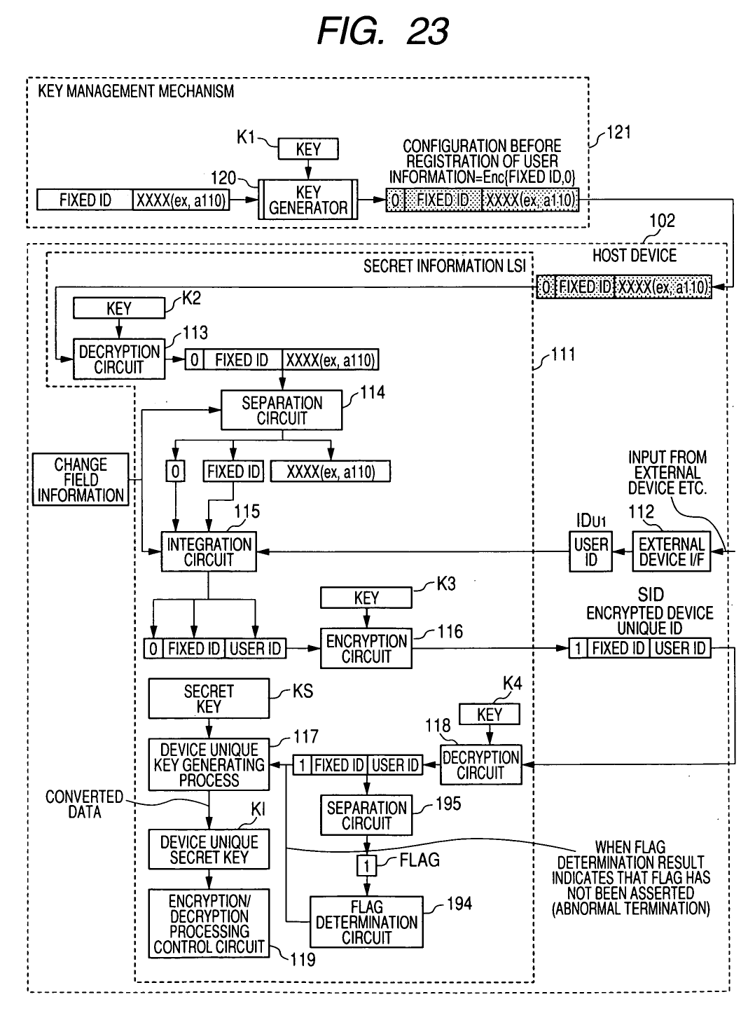

FIG. 23 shows Example 14 of the invention.

In a system shown in FIG. 23, in a key management mechanism 121, a device unique ID having a determination flag region added thereto is generated and encrypted with a key K1 so that an encrypted device unique ID (ID_{E1}) is generated. Key information for opening the encrypted device unique ID (ID_{E1}) is given to a key K2 of a secret information LSI 111 of a host device 102 in advance. When a user ID is to be integrated with a device unique ID (ID₀), the device unique ID (ID₀) is decrypted with the key K2 by a decryption circuit 113, and separated into a determination flag region, a fixed ID portion (ID_{F}) and a user ID portion (ID_{c0}) by a separation circuit 114. Here, a user ID (IDᵤ₁) is integrated with the determination flag region and the fixed ID portion (ID_{F}) by an integration circuit 115 based on the change field information. In the determination flag region, a determination flag indicating that the user ID has been updated is asserted. The device unique ID obtained thus is encrypted with a key K3. The encrypted device unique ID (SID) is stored in a storage portion of the host device.

The encrypted device unique ID (SID) is input to the secret information LSI 111 again and decrypted with a key K4 by a decryption circuit 118. A flag determination region is separated from the decrypted device unique ID by a separation circuit 195. The determination flag region is checked by a flag determination circuit 194. When the determination flag has not been asserted correctly, the processing is terminated abnormally. When the determination flag has been asserted, a device unique key generating process 117 is executed to generate a device unique key KI.

In this Example, when the encrypted device unique ID is decrypted to generate a device unique key, the flag is checked to determine the device unique ID has been updated correctly or not. When the flag has been asserted, the device unique key is generated. When the flag has not been asserted, processing is suspended to prevent the device unique key from being generated.

The same method as that described in Embodiment 1 may be used as the method for inputting change field information and a user ID in this Example. As for control of the number of times with which the device unique ID has been changed, the method described in Embodiment 1 may be combined likewise.

According to the embodiment, a determination flag region is defined in a device unique ID. Accordingly, input of an unauthorized encrypted device unique ID does not lead to operation. Thus, illegal access can be prevented.

The invention is applicable to a system for registration or model change of portable phones etc. because of very high security and simple management.

What is claimed is:

1. A method for generating a device unique key, comprising the steps of:
integrating a fixed ID and a user ID so as to generate a device unique ID, the fixed ID being determined for a host device in advance and stored in a storage portion of the host device, the user ID being able to be determined desirably by a user; and
generating a device unique key based on the device unique ID.

2. The method for generating a device unique key according to claim 1, further comprising the steps of:
making a key generator of a key management mechanism encrypt the fixed ID to thereby generate an encrypted fixed ID;
making a secret information processing portion of the host device decrypt the encrypted fixed ID and store the decrypted fixed ID as the fixed ID into the storage portion of the host device;
making an I/F of the host device acquire the user ID the user can determine desirably; and
making the secret information processing portion of the host device integrate the fixed ID and the user ID to thereby generate a device unique ID.

3. The method for generating a device unique key according to claim 2, the step of generating the device unique ID including the steps of:
generating change field information defining a field of the device unique ID in which the user ID should be input; and
making the host device input the user ID into a desired field of the device unique ID in accordance with the change field information so as to integrate the user ID with the fixed ID to thereby generate the device unique ID.

4. The method for generating a device unique key according to claim 2, further comprising the steps of:
making the secret information processing portion of the host device encrypt the device unique ID to thereby generate an encrypted device unique ID;
storing the encrypted device unique ID into the storage portion of the host device; and
making the secret information processing portion of the host device generate a device unique key based on the device unique ID.

5. The method for generating a device unique key according to claim 2, further comprising the steps of:
making the secret information processing portion of the host device generate an authentication key based on mutual authentication between the host device and a target device; and
making the secret information processing portion of the host device generate a device unique key based on the device unique ID and the authentication key generated in the step of generating the authentication key.

6. The method for generating a device unique key according to claim 3, further comprising the steps of:
making the key generator of the key management mechanism encrypt the change field information to thereby generate encrypted change field information, and store the encrypted change field information into the host device; and
making the secret information processing portion of the host device acquire the encrypted change field information and decrypt the change field information.

7. The method for generating a device unique key according to claim 3, further comprising the step of:
making an external device I/F of the host device acquire the change field information from an external device.

8. The method for generating a device unique key according to claim 7, wherein:
the step of acquiring the change field information is a step of acquiring the change field information as encrypted change field information.

9. The method for generating a device unique key according to claim 3, further comprising the step of:
calculating a hash value of the change field information.

10. The method for generating a device unique key according to claim 3, wherein:
the change field information is plain text.

11. The method for generating a device unique key according to claim 1, further comprising the step of:
making an external device I/F of the host device acquire the user ID from an external device when the device unique ID is registered, replaced, updated or changed.

12. The method for generating a device unique key according to claim 3, wherein:
the step of acquiring the user ID is a step of acquiring the user ID as an encrypted user ID.

13. The method for generating a device unique key according to claim 11, wherein:
the step of acquiring the user ID is a step of acquiring the user ID as an encrypted user ID.

14. The method for generating a device unique key according to claim 3, further comprising the step of:
calculating a hash value of the user ID.

15. The method for generating a device unique key according to claim 11, further comprising the step of:
calculating a hash value of the user ID.

16. The method for generating a device unique key according to claim 3, wherein:
the user ID is plain text.

17. The method for generating a device unique key according to claim 11, wherein:
the user ID is plain text.

18. The method for generating a device unique key according to claim 1, further comprising the step of:
making a secret information processing portion of the host device determine the number of times with which the device unique ID has been changed, and update the device unique ID as long as the number of times with which the device unique ID has been changed is not larger than a predetermined number.

19. The method for generating a device unique key according to claim 1, wherein:
the host device stores initial-value of the user ID; and
it is determined whether the initial-value of the user ID coincides with a user ID portion obtained by a secret information processing portion of the host device decrypting an encrypted fixed ID stored by the host device, or not.

20. The method for generating a device unique key according to claim 1, further comprising the steps of:
making a secret information processing portion of the host device encrypt the device unique ID to thereby generate an encrypted device unique ID; and
outputting the encrypted device unique ID to the outside of the secret information processing portion.

21. The method for generating a device unique key according to claim 20, wherein:
the host device stores initial-value of the user ID; and
it is determined whether a user ID obtained by decrypting and then separating the encrypted device unique ID input again into the secret information processing portion coincides with the initial value of the user ID stored by the host device in advance, or not.

22. The method for generating a device unique key according to claim 1, further comprising the steps of:
making a secret information processing portion of the host device encrypt the device unique ID to thereby generate an encrypted device unique ID;
making the secret information processing portion of the host device decrypt an encrypted device unique ID to thereby generate a device unique ID, the encrypted device unique ID being input from the storage portion of the host device through an I/F of the host device; and
comparing a user ID input from the outside of the host device through the I/F with a user ID portion of the decrypted device unique ID, and regarding the input user ID as unauthorized and suspending processing when the input user ID does not coincide with the user ID portion of the decrypted device unique ID.

23. The method for generating a device unique key according to claim 1, further comprising the steps of:
making a key generator of a key management mechanism add a determination flag region and encrypt the fixed ID to thereby generate an encrypted fixed ID;
making a secret information processing portion of the host device integrate the fixed ID with the user ID and update the determination flag region to thereby generate a device unique ID; and
generating a device unique key based on the device unique ID.

24. The method for generating a device unique key according to claim 23, further comprising the steps of:
determining whether the determination flag region has been updated or not; and
regarding the determination flag region as unauthorized and suspending processing when the determination flag region has not been updated.

25. The method for generating a device unique key according to claim 1, wherein:
the storage portion is disposed in a secret information processing portion.

26. The method for generating a device unique key according to claim 1, wherein:
the storage portion is disposed out of a secret information processing portion.

27. A device unique ID, comprising:
a fixed ID, determined for a host device in advance; and
a user ID, capable of being desirably determined by a user;
wherein the fixed ID and the user ID are integrated with each other so that the device unique ID has a data structure which can be changed whenever the device unique ID is used.

28. The device unique ID according to claim 27, wherein:
the device unique ID has a data structure in which the fixed ID and the user ID are integrated based on change field information defining a field of the device unique ID the user ID should be input into.

29. A secret information LSI, comprising:
a secret information processing portion, generating a device unique ID;
wherein the device unique ID has a data structure in which a fixed ID determined for a host device in advance and a user ID which is capable of being desirably determined by the user are integrated with each other so that the data structure can be changed whenever the device unique ID is used.

30. The secret information LSI according to claim 29, wherein:
the secret information processing portion integrates the fixed ID with the user ID based on change field information so as to generate the device unique ID, the change field information defining a field of the device unique ID the user ID should be input into.

31. A host device comprising:
a secret information LSI according to claim 29.

32. The host device according to claim 31, further comprising:
a storage portion, storing the fixed ID decrypted; and
an I/F, inputting the user ID the user can determine desirably;
wherein the fixed ID is read from the storage portion, and the fixed ID and the user ID input through the I/F are integrated to generate a device unique ID.

33. The host device according to claim 31, wherein:
the secret information LSI includes an encryption circuit for encrypting the device unique ID to thereby generate an encrypted device unique ID.

34. The host device according to claim 31, wherein:
the secret information LSI includes an authentication key generating circuit for generating an authentication key based on mutual authentication between the host device and a target device.

35. The host device according to claim 31, further comprising:
a storage region for storing encrypted change field information.

36. The host device according to claim 31, further comprising:
an external device I/F through which the user ID can be acquired from an external device when the device unique ID is registered, replaced, updated or changed.

37. The host device according to claim 31, further comprising:
an external device I/F through which the change field information can be input from the external device.

38. The host device according to claim 31, further comprising:
a determination circuit for determining the number of times with which the device unique ID has been changed.

39. A recording medium with an authentication function, used in a host device according to claim 31.

40. A portable terminal having a recording medium with an authentication function according to claim 39.
